(19) United States
(12) Patent Application Publication
(10) Pub. No.: US 2006/0020473 A1
(43) Pub. Date: Jan. 26, 2006

(54) Method, apparatus, and program for dialogue, and storage medium including a program stored therein

(76) Inventors: Atsuo Hiroe, Kanagawa (JP); Helmut Lucke, Tokyo (JP); Yasuhiro Kodama, Kanagawa (JP)

Correspondence Address: FROMMER LAWRENCE & HAUG LLP, 745 FIFTH AVENUE, NEW YORK, NY, 10151, US

(21) Appl. No.: 11/188,378

(22) Filed: Jul. 25, 2005

(30) Foreign Application Priority Data
Jul. 26, 2004 (JP) 2004-217429

(51) Int. Cl. G10L 21/00

(52) U.S. Cl. 704/275

(57) ABSTRACT

A dialgue apparatus for interacting by outputting a response sentence in response to an input sentence includes a formal response acquisition unit configured to acquire a formal response sentence in response to the input sentence, a practical response acquisition unit configured to acquire a practical response sentence in response to the input sentence, and an output control unit configured to control outputting of the formal response sentence and the practical response sentence such that a conclusive response sentence is output in response to the input sentence.

### CROSS REFERENCES TO RELATED APPLICATIONS

The present invention contains subject matter related to Japanese Patent Application JP 2004-217429 filed in the Japanese Patent Office on Jul. 26, 2004, the entire contents of which are incorporated herein by reference.

### BACKGROUND OF THE INVENTION

1. Field of the Invention

The present invention relates to a method, apparatus, and a program for dialogue, and a storage medium including a program stored therein. More particularly, the present invention relates to a method, apparatus, and a program for interacting by quickly outputting a response that is appropriate in form and content in response to an input sentence, and a storage medium including such a program stored therein.

2. Description of the Related Art

Voice dialogue systems for interacting with a person via a voice can be roughly grouped into two types: systems for the purpose of a particular goal; and systems for talks (chats) about unspecified topics.

An example of a voice dialogue system for the purpose of a particular goal is a voice-dialogue ticket reservation system. An example of a voice dialogue system for talks about unspecified topics is a “chatterbot”, a description of which may be found, for example, in “Chatterbot Is Thinking” (accessible, as of Jul. 26, 2004, at URL address “http://www.ycf.nanet.co.jp/˜skato/muno/index.shtml”).

The voice dialogue system for the purpose of a particular goal and the voice dialogue system for talks about unspecified topics are different in design philosophy associated with how to respond to a voice input (utterance) given by a user.

In voice dialogue systems for particular goals, it is necessary to output a response that leads a user to make a speech to provide information necessary to reach a goal. For example, in a voice dialogue system for reservations for airline tickets, when information about a departure date, a departure time, a departure airport, and a destination airport is necessary to make a reservation, if a user says “February 16, from Tokyo to Sapporo”, then it is desirable that the voice dialogue system can detect lack of information about the departure time and return a response “What departure time would you like?”.

On the other hand, in voice dialogue systems for talks about nonspecific topics, there is no unique solution as to how to respond. However, in free talks about unspecified topics it is desirable that the voice dialogue system can return a response that attracts the interest of a user or a response that causes the user to feel that the voice dialogue system understand what the user says, thereby causing the user to want to continue the talk with the voice dialogue system.

To output a response that gives to a user a feeling that the system understands what the user says, it is needed that the response be consistent in form and content (topic) with a speech of a user.

For example, when a user ask a question that is expected to be answered by a sentence starting with “Yes” or “No”, a response that is correct in form should start with “Yes” (or a similar word indicating affirmation” or “No” (or a similar word indicating negation). In a case in which a user makes a greeting speech, a response that is correct in form is a greeting sentence corresponding to the greeting expression given by the user (for example, “Good morning” is a correct response to “Good morning”, and “Welcome home” to “Hi, I'm back”). A sentence starting with a word of agreement can be correct in form as a response.

On the other hand, when a user talks about weather, a sentence about weather is a response that is correct in content.

For example, when a user says “I'm worried about whether it will be fine tomorrow.”, an example of a response that is correct in both form and content is “Yeah, I am also worried about the weather”. Of the sentence “Yeah, I'm also worried about the weather”, the first part “Year” is an expression of agreement and is correct in form. The following part “I'm also worried about the weather” is correct in content.

If the voice dialogue system outputs a response that is consistent in both form and content, such as the above example, the response given to a user an impression that the system understands what the user says.

However, in the conventional voice dialogue systems, it is difficult to produce a response that is consistent in both form and content.

One known method to produce a response in a free conversation is by rules, and another known method is by examples.

The method by rules is employed in a program called Eliza, which is cited, for example, in “What ELIZA talks” (accessible, as of Jul. 26, 2004, at URL address http://www.ycf.nanet.co.jp/˜skato/muno/eliza.html or “Language Engineering” (Makoto Nagao, Shokodo, pp. 226-228).

In the method using rules, a response is produced using a set of rules each of which defines a sentence to be output when an input sentence includes a particular word or an expression.

For example, when a user says “Thank you very much”, if there is a rule that the response to an input sentence including “Thank you” should be “You are welcome”, then a response “You are welcome” is produced in accordance with that rule.

However, although it is rather easy to describe rules to produce responses that are consistent in form, it is difficult to describe rules to produce responses that are consistent in content. Besides, there can be a huge number of rules to produce responses that are consistent in content, and a very tedious job is needed to maintain such a huge number of rules.

It is also known to produce a response using response templates, instead of using the by-rule method or the by-example method (as disclosed, for example, in Japanese Unexamined Patent Application Publication No. 2001-357053). However, this method also has problems similar to those with the method using rules.

An example of a by-method example is disclosed, for example, in “Building of Dictionary” (accessible, as of Jul. 26, 2004, at URL address http://www.ycf.nanet.co.jp/˜skato/muno/dict.html), in which a dictionary is built based on a log of a chat made between persons. In this technique, a key is extracted from an (n−1)th sentence, and an n-th sentence is employed as a value for the key extracted from the (n−1)th sentence. This process is repeatedly performed for all sentences to produce a dictionary. A “log of chats” described in this technique corresponds to an example.

That is, in this technique, a log of chats or the like can be used as examples of sentences, and thus it is easy to collect a large number of examples compared to the case in which a large number of rules are manually described, and it is possible to produce a response in many ways based on the large number of examples of sentences.

However, in the method by examples, in order to produce a response that is consistent in both form and content, it is required that there must be at least one example corresponding to a response.

In many cases, an example corresponds to a response that is consistent only in either form or content. In other words, although it is easy to collect example sentences corresponding to response sentences that are consistent only in either form or content, it is not easy to collect example sentences corresponding to response sentences that are consistent in both form and content.

In the voice dialogue systems, in addition to the consistency of responses in terms of form and content with a speech made by a user, the timing of outputting a response is also an important factor that determines whether the user has a good feeling for the system. In particular, the response time, that is, the time needed for the voice dialogue system to output a response since a user says something, is important.

The response time depends on a time needed to perform speech recognition on a speech made by a user, a time needed to produce a response corresponding to the speech made by the user, a time needed to produce a voice waveform corresponding to the response by means of speech synthesis and play back the voice waveform, and a time to handle overhead processing.

Of these times, the time needed to produce a response is specific to the dialogue system (dialogue apparatus). In the method of producing a response using rules, the smaller number of rules, the shorter time is needed to produce a response. Also in the method of producing a response using examples, the smaller number of examples, the shorter time is needed to produce a response.

However, in order to output a response in many ways such that a user does not become tired of responses, it is needed to prepare a rather large number of rules or examples. Thus, there is a need for a technique capable of producing a response in a short time using a sufficiently large number of rules or examples.

### SUMMARY OF THE INVENTION

As described above, it is desirable that the dialogue system be capable of returning a response that is appropriate in both form and content such that a user has a feeling that the dialogue system understands what a user says. It is also desirable that the dialogue system can quickly respond to what a user says, such that the user is not frustrated.

In view of the above, the present invention provides a technique to quickly return a response that is appropriate in both form and content.

A dialogue apparatus according to an embodiment of the present invention includes formal response sentence acquisition means for acquiring a formal response sentence in response to an input sentence, practical response sentence acquisition means for acquiring a practical response sentence in response to the input sentence, and output control means for controlling outputting of the formal response sentence and the practical response sentence such that a conclusive response sentence is output in response to the input sentence.

A method of dialogue according to an embodiment of the present invention includes the steps of acquiring a formal response sentence in response to the input sentence, acquiring a practical response sentence in response to the input sentence, and controlling outputting of the formal response sentence and the practical response sentence such that a conclusive response sentence is output in response to the input sentence.

A program according to an embodiment of the present invention includes the steps of acquiring a formal response sentence in response to the input sentence, acquiring a practical response sentence in response to the input sentence, and controlling outputting of the formal response sentence and the practical response sentence such that a conclusive response sentence is output in response to the input sentence.

A program stored on storage medium according to an embodiment of the present invention includes the steps of acquiring a formal response sentence in response to the input sentence, acquiring a practical response sentence in response to the input sentence, and controlling outputting of the formal response sentence and the practical response sentence such that a conclusive response sentence is output in response to the input sentence.

A dialogue apparatus according to an embodiment of the present invention includes a formal response sentence acquisition unit configured to acquire a formal response sentence in response to the input sentence, a practical response sentence acquisition unit configured to acquire a practical response sentence in response to the input sentence, and an output unit configured to control outputting of the formal response sentence and the practical response sentence such that a conclusive response sentence is output in response to the input sentence.

In the embodiments of the present invention, as described above, in response to an input sentence, a formal response sentence is acquired, and furthermore a practical response sentence is acquired. A final response sentence to the input sentence is output by controlling outputting of the formal response sentence and the practical response sentence.

According to one of the embodiments of the present invention, it is possible to output a response that is appropriate in both format and content, and such a response can be output in a short time.

### BRIEF DESCRIPTION OF THE DRAWINGS

FIG. 1 is a block diagram showing a voice dialogue system according to an embodiment of the present invention;

FIG. 2 is a block diagram showing an example of a construction of a response generator;

FIG. 3 is a diagram showing examples recorded in an example database;

FIG. 4 is a diagram showing a process performed by a formal response sentence generator to produce a formal response sentence;

FIG. 5 is a diagram showing a vector space method;

FIG. 6 shows examples of vectors representing an input sentence and input examples;

FIG. 7 shows examples recorded in an example database;

FIG. 8 is a diagram showing a process performed by a practical response sentence generator to produce a practical response sentence;

FIG. 9 is As described above, the dialogue log recorded in the dialogue log database 15;

FIG. 10 is a diagram showing a process of producing a practical response sentence based on a dialogue log;

FIG. 11 is a diagram showing a process of producing a practical response sentence based on a dialogue log;

FIG. 12 is a graph showing a function having a characteristic similar to a forgetting curve;

FIG. 13 is a diagram showing a process performed by a response output controller to control outputting of sentences;

FIG. 14 is a flow chart showing a speech synthesis process and a dialogue process according to an embodiment of the invention;

FIG. 15 is a flow chart showing a dialogue process according to an embodiment of the invention;

FIG. 16 is a flow chart showing a dialogue process according to an embodiment of the invention;

FIG. 17 shows examples of matching between an input sentence and a model input sentence according to a DP matching method;

FIG. 18 shows examples of matching between an input sentence and a model input sentence according to a DP matching method;

FIG. 19 shows a topic space;

FIG. 20 is a flow chart showing a dialogue process according to an embodiment of the invention;

FIG. 21 is a diagram showing a definition of each of two contexts located on left-hand and right-hand sides of a phoneme boundary;

FIG. 22 is a diagram showing a definition of each of two contexts located on left-hand and right-hand sides of a phoneme boundary;

FIG. 23 is a diagram showing a definition of each of two contexts located on left-hand and right-hand sides of a phoneme boundary; and

FIG. 24 is a block diagram showing a computer according to an embodiment of the present invention.

### DESCRIPTION OF THE PREFERRED EMBODIMENTS

The present invention is described in further detail below with reference to embodiments in conjunction with the accompanying drawings.

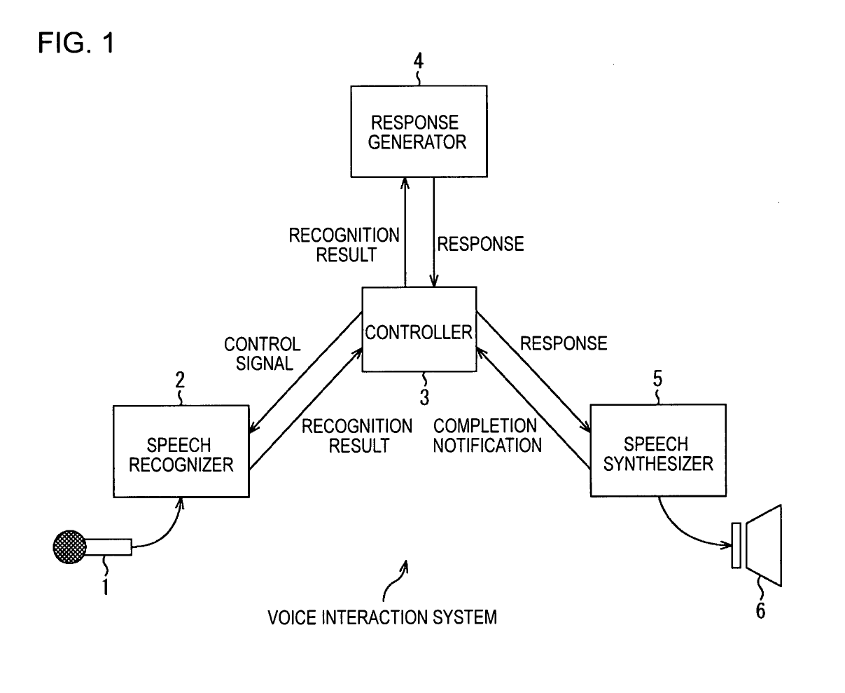

FIG. 1 shows a voice dialogue system according to an embodiment of the present invention.

This voice dialogue system includes a microphone 1, a speech recognizer 2, a controller 3, a response generator 4, a speech synthesizer 5 and a speaker 6, which are configured to interact via voice with a user.

The microphone 1 converts a voice (speech) uttered by a user or the like into a voice signal in the form of an electric signal and supplies it to the speech recognizer 2.

The speech recognizer 2 performs speech recognition on the voice signal supplied from the microphone 1 and supplies a series of words obtained as a result of the speech recognition (recognition result) to the controller 3.

In the above-described speech recognition performed by the speech recognizer 2 may be based on, for example, the HMM (Hidden Markov Model) method or any other proper algorithm.

The speech recognition result supplied from the speech recognizer 2 to the controller 3 may be a most likely recognition candidate (with a highest score associated with likelihood) of a series of words or may be most likely N recognition candidates. In the following discussion, it is assumed that a most likely recognition candidate of a series of words is supplied as the speech recognition result from the speech recognizer 2 to the controller 3.

The speech recognition result supplied from the speech recognizer 2 to the controller 3 does not necessarily need to be in the form of a series of words, but the speech recognition result may be in the form of a word graph.

The voice dialogue system may include a keyboard in addition to or instead of the microphone 1 and the speech recognizer 2 such that a user is allowed to input text data via the keyboard and the input text data is supplied to the controller 3.

Text data obtained by performing character recognition on characters written by a user or text data obtained by performing optical character recognition (OCR) on an image read using a camera or a scanner may also be supplied to the controller 3.

The controller 3 is responsible for control over the whole voice dialogue system.

More specifically, for example, the controller 3 supplies a control signal to speech recognizer 2 to control the speech recognizer 2 to perform speech recognition. The controller 3 supplies the speech recognition result output from the speech recognizer 2 as an input sentence to the response generator 4 to produce a response sentence in response to the input sentence. The controller 3 receives the response sentence from the response generator 4 and supplies the received response sentence to the speech synthesizer 5. If the controller 3 receives from the speech synthesizer 5 a completion notification indicating that the speech synthesis is completed, the controller 3 performs necessary processing in response to the completion notification.

The response generator 4 produces a response sentence to the input sentence supplied as the speech recognition result from the controller 3, that is, the response generator 4 produces text data to respond to a speech of a user, and the response generator 4 supplies the produced response sentence to the controller 3.

The speech synthesizer 5 produces a voice signal corresponding to the response sentence supplied from the controller 3 by using a speech synthesis technique such as speech synthesis by rule, and the speech synthesizer 5 supplies the resultant voice signal to the speaker 6.

The speaker 6 outputs (radiates) a synthesized voice in accordance with the voice signal received from the speech synthesizer 5.

In addition to or instead of producing a voice signal by using the speech synthesis technique, the speech synthesizer 5 may store voice data corresponding to typical response sentences in advance and may play back the voice data.

In addition to or instead of outputting, from the speaker 6, a voice corresponding to a response sentence supplied from the controller 3, the response sentence may be displayed on a display or may be projected on a screen using a projector.

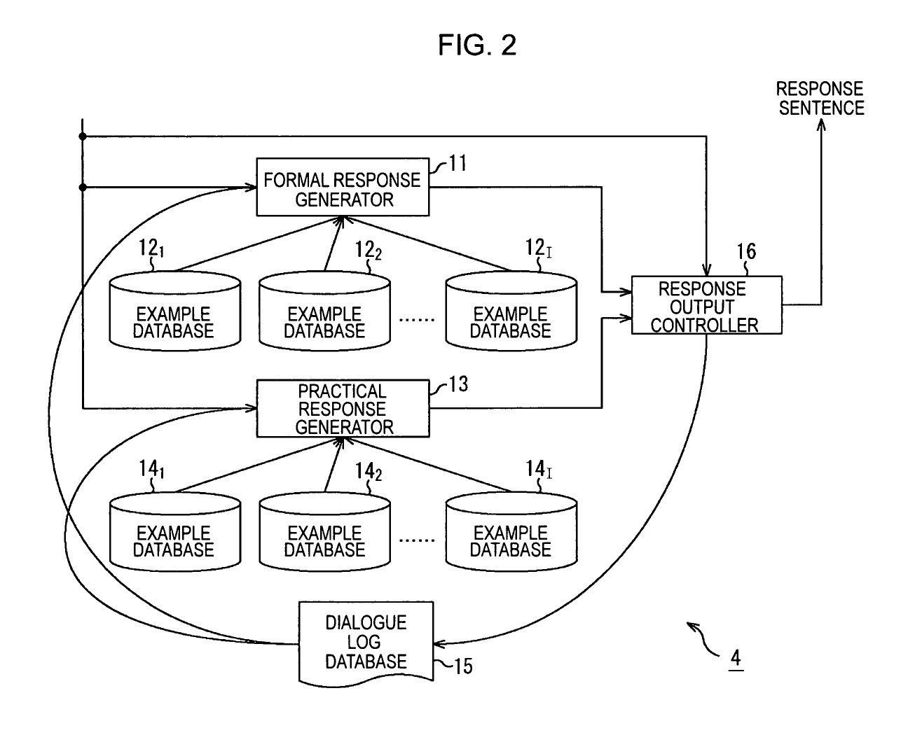

FIG. 2 shows an example of an inner structure of the response generator 4 shown in FIG. 1.

In FIG. 2, an input sentence supplied as a speech recognition result from the speech recognizer 2 (FIG. 1) is supplied to a formal response sentence generator 11. The formal response sentence generator 11 produces (acquires) a formal response sentence that is consistent in form with the input sentence, based on the input sentence and examples (examples of speech expressions) stored in example databases 12₁, 12₂, . . . , 12_{I}, and furthermore, as required, based on a dialogue log stored in a dialogue log database 15. The resultant formal response sentence is supplied to a response output controller 16.

Thus, in the present embodiment, the producing of the sentence (formal response sentence) by the formal response sentence generator 11 is based on the by-example method. Alternatively, the formal response sentence generator 11 may produce a response sentence by a method other than the by-example method, for example, by-rule method. In the case in which the formal response sentence generator 11 produces a response sentence by rules, the example databases 12_{I} are replaced with rule database.

The example databases 12_{I} (i=1, 2, . . . ,I) stores examples used by the formal response sentence generator 11 to produce a formal response sentence consistent at least in form with an input sentence (a speech).

Examples stored in an example databases 12_{I} are different in category from examples stored in another example database 12ᵢ. For example, examples in terms of greetings are stored in the example database 12_{I}, and examples in terms of agreement are stored in the example database 12_{i′}. As described above sets of examples are stored in different example databases depending on categories of sets of examples.

In the following discussion, example databases 12₁, 12₂, . . . , 12_{I} are generically described as example databases 12 unless it is needed to distinguish them from each other.

The input sentence, which is supplied as the speech recognition result from the speech recognizer 2 (FIG. 1) and which is the same as that supplied to the formal response sentence generator 11, is supplied to a practical response sentence generator 13. The practical response sentence generator 13 produces (acquires) a practical response sentence that is consistent in content (topic) with the input sentence, based on the input sentence and examples stored in example databases 14₁, 14₂, . . . , 14_{J} and furthermore, as required, based on a dialogue log stored in a dialogue log database 15. The resultant practical response sentence is supplied to a response output controller 16.

Thus, in the present embodiment, the producing of the sentence (practical response sentence) by the practical response sentence generator 13 is based on the by-example method. Alternatively, as with the formal response sentence generator 11, the practical response sentence generator 13 may produce a response sentence by a method other than the by-example, for example, the by-rule method. In the case in which the practical response sentence generator 13 produces a response sentence by rules, the example databases 14_{J} are replaced with rule database.

The example databases 12_{J} (j=1, 2, . . . ,J) stores examples used by the practical response sentence generator 13 to produce a practical response sentence, that is, examples that are consistent in terms with at least contents with sentences (speeches).

Each unit of example stored in each example database 14_{J} includes a series of speeches made during a talk on a particular topic from the beginning to the end of the talk. For example, in a talk, if a phrase for changing the topic, such as “by the way”, occurs, then the phrase can be regarded as the beginning of a new unit.

In the following description, example databases 14₁, 14₂, . . . , 14_{J} are generically described as example databases 14 unless it is needed to distinguish them from each other.

The dialogue log database 15 stores a dialogue log. More specifically, one of or both of an input sentence supplied from the response output controller 16 and a response sentence (conclusive response sentence) finally output in response to the input sentence are recorded as the dialogue log in the dialogue log database 15. As described above, the dialogue log recorded in the dialogue log database 15 is used, as required, by the formal response sentence generator 11 or the practical response sentence generator 13 in the process of producing a response sentence (a formal response sentence or a practical response sentence).

The response output controller 16 controls outputting of the formal response sentence from the formal response sentence generator 11 and the practical response sentence from the practical response sentence generator 13 such that the conclusive response sentence to the input sentence is output to the controller 3 (FIG. 1). More specifically, the response output controller 16 acquires the conclusive response sentence to be output in response to the input sentence by combining the formal response sentence and the practical response sentence produced in response to the input sentence, and the response output controller 16 output the resultant conclusive response sentence to the controller 3.

The input sentence obtained as the result of the speech recognition performed by the speech recognizer 2 (FIG. 1) is also supplied to the response output controller 16. After the response output controller 16 outputs the conclusive response sentence in response to the input sentence, the response output controller 16 supplies the conclusive response sentence together with the input sentence to the dialogue log database 15. The input sentence and the conclusive response sentence supplied from the response output controller 16 are stored as a dialogue log in the dialogue log database 15, as described earlier.

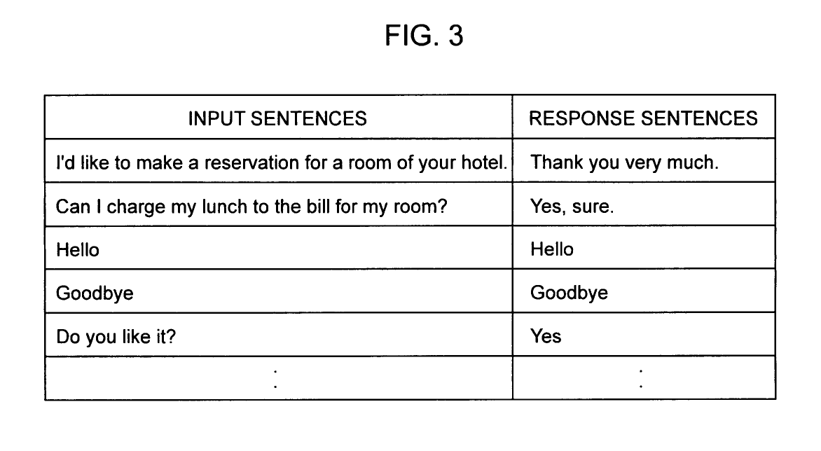

FIG. 3 shows an example, which is stored in the example database 12 and which is used by the formal response sentence generator 11 shown in FIG. 2 to produce a formal response sentence.

Each example stored in the example database 12 is described in the form of a set of an input expression and a response expression uttered in response to the input sentence.

In order that examples stored in the example database 12 can be used by the formal response sentence generator 11 to produce formal response sentences, a response expression in each pair should correspond to an input expression of that pair and should be consistent at least in form with the input expression of that pair.

Examples of response expressions stored in the example database 12 are affirmative responses such as “Yes” or “That's right”, negative responses such as “No” or “No, it isn't”, greeting responses such as “Hello” or “You are welcome”, and words thrown during a speech, such as “uh-huh”. An input expression is coupled with a response expression that is natural in form as a response to the input expression.

The example database 12 shown in FIG. 3 may be built, for example, as follows. First, response expressions, which are suitable as formal response expressions, are extracted from a description of an actual dialog such as a chat log accessible on the Internet. An expression immediately previous to each extracted response expression is then extracted as an input expression corresponding to the response expression, and sets of input and response expressions are described in the example database 12. Alternatively, original sets of input and response expressions may be manually created and described in the example database 12.

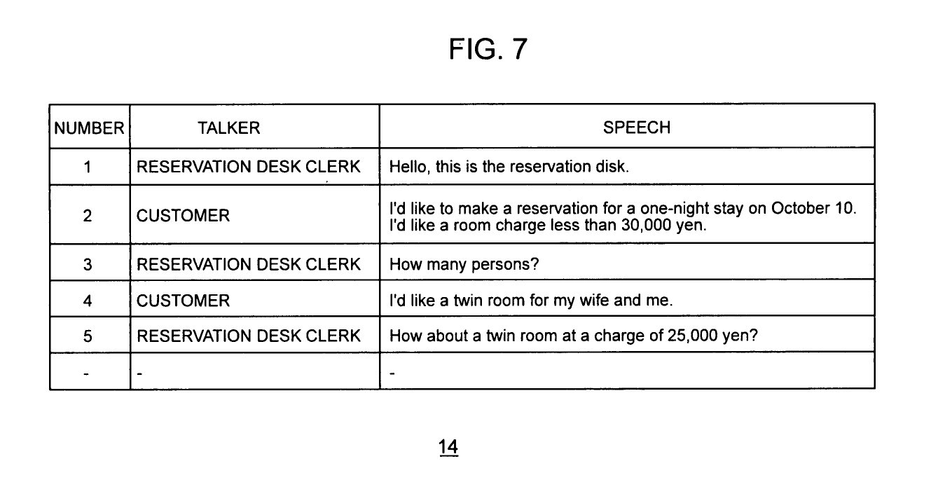

For later use in a matching process described later, examples (input expressions and response expressions) stored in the example database 12 are described in a form in which each word is delimited by a delimiter. In the example shown in FIG. 3, a space is used as the delimiter. For a language in which words are not spaced from each other, such as Japanese, the space is removed as required during the process performed by the formal response sentence generator 11 or the response output controller 16. This is also true for example expressions described in the example database 14, which will be described later with reference to FIG. 7.

In the case of a language such as Japanese in which words are not spaced from each other, example expressions may be stored in a non-spaced form, and words in expressions may be spaced from each other when the matching process is performed.

Note that in the present invention, the term “word” is used to describe a series of characters defined from the viewpoint of convenience for processing, and words are not necessarily equal to linguistically defined words. This is also true for “sentences”.

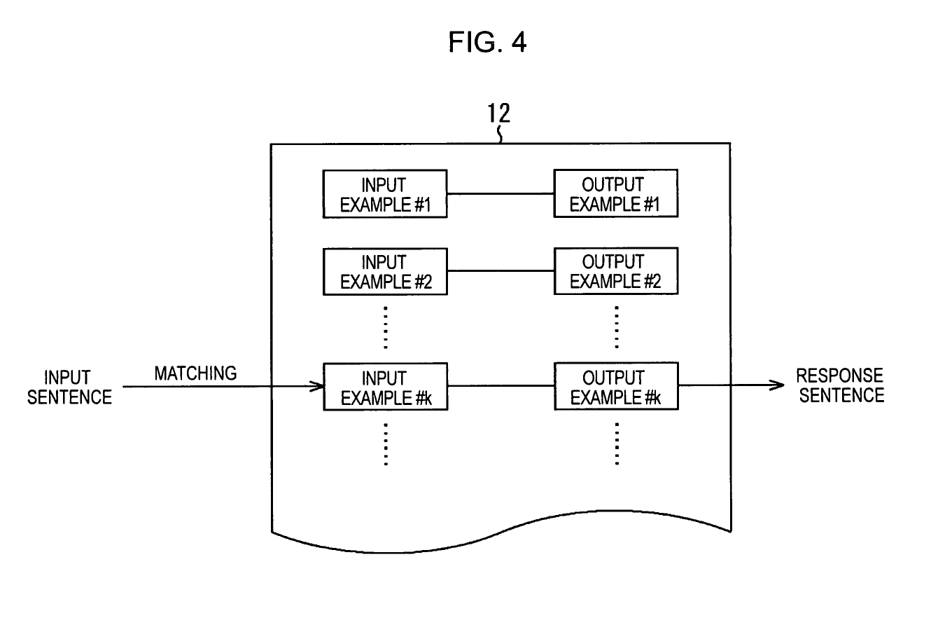

Now, referring to FIGS. 4 to 6, the process performed by the formal response sentence generator 11 shown in FIG. 2 to produce a formal response sentence is described below.

As shown in FIG. 4, the formal response sentence generator 11 produces a formal response sentence in response to an input sentence, based on examples stored in the example database 12.

FIG. 4 schematically illustrates examples stored in the example database 12 shown in FIG. 3, wherein each example is described in the form of a set of an input expression and a corresponding response expression. Hereinafter, an input expression and a response expression in an example will be respectively referred to as an input example and a response example.

As shown in FIG. 4, the formal response sentence generator 11 compares the input sentence with respective input examples #1, #2, . . . , #k . . . stored in the example database 12 and calculates the score indicating the similarity of each input example #1, #2, . . . , #k . . . with respect to the input sentence. For example, if the input example #k is most similar to the input sentence, that is, if the input example #k has a highest score, then, as shown in FIG. 4, the formal response sentence generator 11 selects the response example #k coupled with the input example #k and outputs the selected response example #k as a formal response sentence.

Because the formal response sentence generator 11 is expected to output a formal response sentence that is consistent in terms of the form with the input sentence, the score indicating the similarity between the input sentence and each input example should be calculated by the formal response sentence generator 11 such that the score indicates the similarity in terms of not the content (topic) but the form.

To this end, for example, the formal response sentence generator 11 evaluates matching between the input sentence and respective input examples by using a vector space method.

The vector space method is one of methods widely used in text searching. In the vector space method, each sentence is expressed by a vector and the similarity or the distance between two sentences is given by the angle between two vectors corresponding to respective sentences.

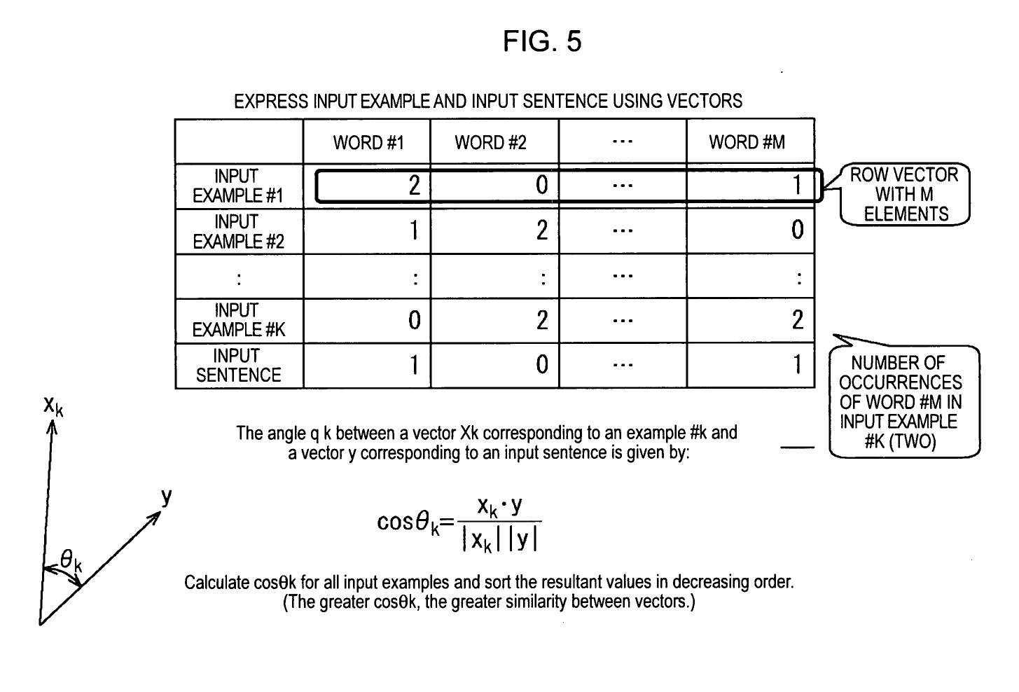

Referring to FIG. 5, the process of comparing an input sentence with model input sentences according to the vector space method is described.

Herein, let us assume that K sets of model input and response expressions are stored in the example database 12, and there are a total of M different words among K input examples (any plurality of occurrences of an identical word is counted as one word).

In this case, as shown in FIG. 5, each input example stored in the example database 12 can be expressed by a vector having M elements corresponding to respective M words #1, #2, . . . , #M.

In each vector representing an input example, the value of an m-th element corresponding to an m-th word #m (m=1, 2, . . . , M) indicates the number of occurrences of the m-th word #m in the input example.

The input sentence can also expressed by a vector including M elements in a similar manner.

If a vector representing an input example #k (k=1, 2, . . . , K) is denoted by Xₖ, a vector representing an input sentence is denoted by y, and the angle between the vector Xₖ and the vector y is denoted by θₖ, then cos θk can be determined according to the following equation (1).

$$cos {θ}_{k} = \frac{{x}_{k} \cdot y}{\vert {x}_{k} \vert \vert y \vert} \qquad ( 1 )$$

where · denotes the inner product, and |z| denotes the norm of the vector z.

cos θₖ has a maximum value of 1 when the direction of the vector Xₖ and the direction of the vector y are the same, and has a minimum value of −1 when the direction of the vector Xₖ and the direction of the vector y are opposite. However, in practice, elements of the vector y of the input sentence and elements of the vector Xₖ of the input example #k are all positive or equal to 0, and thus the minimum value of cos θ_{K} is equal to 0.

In the comparison process using the vector space method, cos θₖ is calculated as the score for all input examples #k, and an input example #k having a highest score is regarded as an input example most similar to the input sentence.

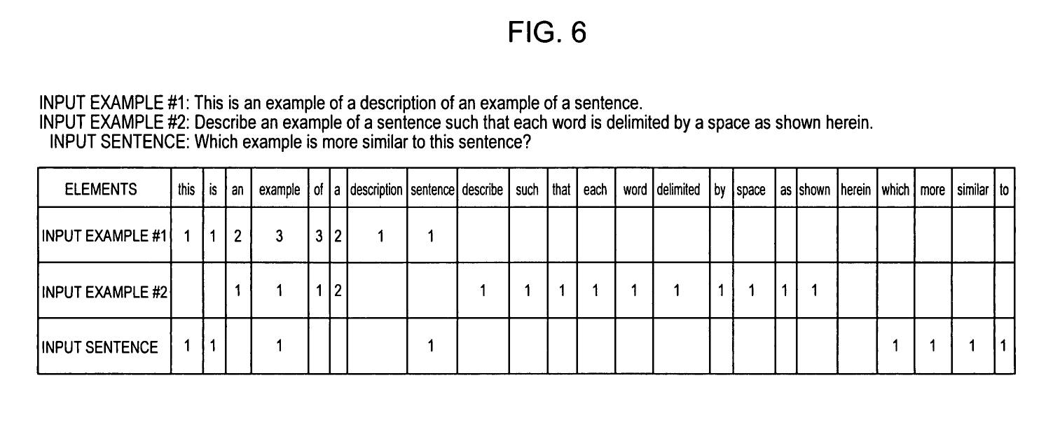

For example, when an input example #1 “This is an example of a description of an input example”, and an input example #2 “Describe an input example such that each word is delimited by a space as shown herein” are stored in the example database 12, if a sentence “Which one of input example is more similar to this sentence?” is given as an input sentence, then vectors representing the respective input examples #1 and #2 are given as shown in FIG. 6.

From FIG. 6, the score of the input example #1, that is, cos θ₁, is calculated as 6/√23√8=0.442, and the score of the input example #2, that is, cos θ₂, is calculated as 2/√19√8=0.162.

Thus, in this specific example, the input example #1 has a highest score and thus is most similar to the input sentence.

In the vector space method, as described earlier, the value of each element of each input sentence or each input example indicates the number of occurrences of a word. Hereinafter, the number of occurrences of a word is referred to as tf (term frequency).

In general, when tf is used as the value of each element of a vector, the score is more influenced by a word which occurs more frequently than by a word which occurs less frequently. In the case of Japanese, particles and auxiliary verbs occur highly frequently. Therefore, use of tf tends to cause the score to be dominated by particles and auxiliary verbs occurring in an input sentence of an input example. For example, when a particle “no” (corresponding to “of” in English) occurs highly frequently in an input sentence, an input example in which the particle “no” occurs highly frequently has a high score.

In text searching, in some cases, to prevent the searching result from being undesirably influenced by particular words occurring highly frequently, the value of each element of a vector is represented not by tf but by tf×idf, wherein idf is a parameter described later.

However, in Japanese sentences, particles and auxiliary verbs represent the form of a given sentence, and thus it is desirable that the comparison made by the formal response sentence generator 11 in the process of producing a formal response sentence be strongly influenced by particles and auxiliary verbs occurring in an input sentence or an input example.

Thus, tf is advantageously employed in the comparison process performed by the formal response sentence generator 11.

Instead of using tf as the value of each vector element, tf×df (in which df (document frequency) is a parameter which will be described later) may be used to enhance the influence of particles and auxiliary verbs in the comparison process performed by the formal response sentence generator 11.

When a word w is given, df for this word, df(w), is given by the following equation (2).
df(w)=log(C(w)+offset) (2)
where C(w) is the number of input examples in which the word w appears, and offset is a constant. In equation (2), for example, 2 is used as the base of logarithm (log).

As can be seen from equation (2), df(w) for the word w increases with increasing number of input examples in which the word w appears.

For example, let us assume that there are 1023 input examples including the particle “no” (corresponding to “of” in English), that is, C(“no”)=1023. Furthermore, let us also assume that offset=1, and the number of occurrences of the particle “no” in the model input sentence #k (or in the input sentence) is 2, that is, tf=2. In this case, in the vector #k representing the input example #k, if tf is used to represent the value of the element corresponding to the word (particle) of “no”, then tf=2. If tf×df is used to represent the value of the element corresponding to the word (particle) of “no”, then tf×df=2×10=20.

Thus, use of tf×df results in an increase in influence of a word that occurs highly frequency in a sentence on the result of the comparison performed by the formal response sentence generator 11.

As described above, in the present embodiment, formal sentences are stored as response expressions in the example database 12, and the formal response sentence generator 11 compares a given input sentence with input examples to determine which input example is most similar in form to the input sentence, thereby producing a response sentence consistent in form with the input sentence.

Note that using tf×df instead of tf as the value of vector element may be applied to input examples and an input sentence or may be applied only to input examples or an input sentence.

In the above-described example, tf×df is used to increase the influence of words such as particles and auxiliary verbs, which represent the form of a sentence, on the comparison process performed by the formal response sentence generator 11. However, the method of increasing the influence of such words is not limited to using of tf×df. For example, values of vector elements of an input sentence or an input example may be set to 0 except for elements corresponding to particles, auxiliary verbs, and other words that represent the form of sentences (that is, elements that have no contribution to the form of sentences are ignored).

In the above-described examples, the formal response sentence generator 11 produces a formal response sentence as a response to an input sentence, based on the input sentence and examples (input examples and response examples) stored in the example database 12. In the production of the formal response sentence, the formal response sentence generator 11 may also refer to the dialogue log stored on the dialogue log database 15. The production of a response sentence based also on the dialogue log may be performed in a similar manner to the production of a practical response sentence by the practical response sentence generator 13 as will be described in detail later.

FIG. 7 shows examples stored in the example database 14, for use by the practical response sentence generator 13 shown in FIG. 2 to produce a practical response sentence.

In the example database 14, for example, examples are stored in a form that allows speeches to be distinguished from each other. In the example shown in FIG. 7, examples are stored in the example database 14 such that an expression of one speech (one utterance) is described in one record (one row).

In the example shown in FIG. 7, a talker of each speech and an expression number identifying the speech are also described together with an expression of the speech in each record. The expression number is assigned to each example sequentially in the order of speech, and the records are sorted in the ascending order of the expression number. Thus, an example with an expression number is a response to an example with an immediately previous expression number.

In order that examples stored in the example database 14 are used by the practical response sentence generator 14 to produce practical response sentences, each example should be consistent at least in content with an immediately previous example.

The examples stored in the example database 14 shown in FIG. 7 are based on ATR (Advanced Telecommunications Research Institute International) trip conversation corpus” (http: Examples may also be produced based on a record of a round-table discussion or an interview. As a matter of course, original examples may be manually created.

As described earlier with reference to FIG. 3, the examples shown in FIG. 7 are stored in the form in which each word is delimited by a space. Note that in a language such as Japanese, it is not necessarily needed to delimit each word.

It is desirable that the examples described in the example database 14 be separated such that one set of speeches of a dialog is stored as one piece of data (in one file).

When examples are described such that each record includes one speech as shown in FIG. 7, it is desirable that each speech in a record be a response to a speech recorded in an immediately previous record. If editing such as changing of the order of records or deleting of some record is performed, the editing can cause some record to become no longer a response to an immediately previous record. Therefore, when examples are described in the form in which one record includes one speech, it is desirable not to perform editing.

On the other hand, in the case in which examples are described such that a set of an input example and a corresponding response example is described in a record as shown in FIG. 3, it is allowed to perform editing such as changing of the order of records or deleting of some record, because, after the edition, any record still includes a set of an input example and a corresponding response example.

A set of an input example and a corresponding response example, such as that shown in FIG. 3, may be produced by employing a speech in an arbitrary record shown in FIG. 7 as an input example and employing a speech in an immediately following record as a response example.

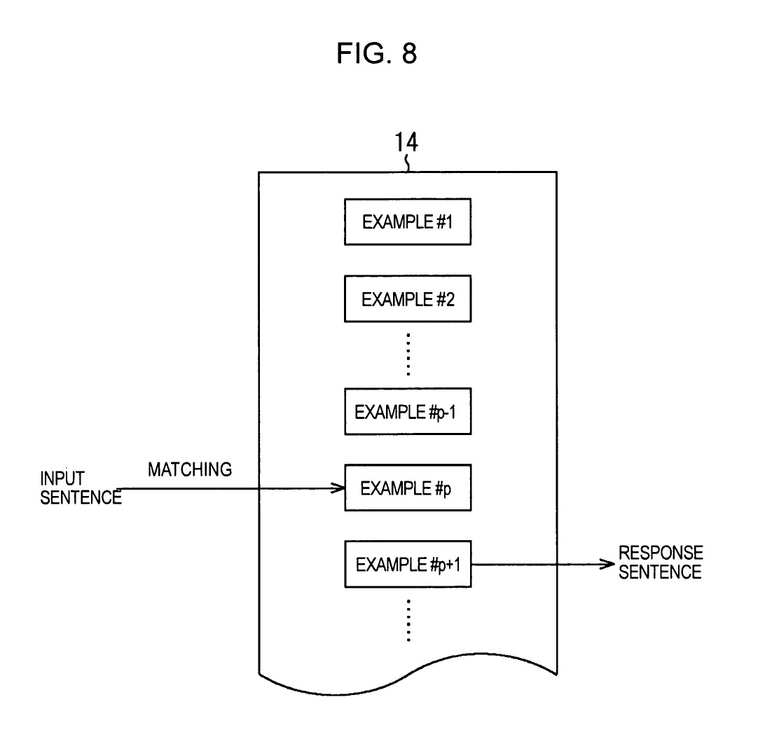

Referring now to FIG. 8, a process performed by the practical response sentence generator 13 shown in FIG. 2 to produce a practical response sentence is described below.

FIG. 8 schematically shows examples stored in the example database 14, wherein the examples are recorded in the order of speeches.

The practical response sentence generator 11 produces a practical response sentence as a response to an input sentence, based on the examples stored in the example database 14, such as those shown in FIG. 8.

As shown in FIG. 8, the examples stored in the example database 14 are described such that speeches in a dialog are recorded in the order of speech.

As shown in FIG. 8, the practical response sentence generator 13 compares a given input sentence with each of examples #1, #2, . . . , #p−1, #p, #p+1, . . . stored in the example database 14 and calculates the score indicating the similarity of each example with respect to the input sentence. For example, if an example #p is most similar to the input sentence, that is, if the example #p has a highest score, then, as shown in FIG. 8, the practical response sentence generator 13 selects an example #p+1 immediately following the example #p and outputs the selected example #p+1 as a practical response sentence.

Because the practical response sentence generator 13 is expected to output a practical response sentence that is consistent in terms of the content with the input sentence, the score indicating the similarity between the input sentence and each example should be calculated by the practical response sentence generator 13 such that the score indicates the similarity in terms of not the form but the content.

The comparison to evaluate the similarity between the input sentence and examples in terms of content may also be performed using the vector space method described earlier.

When the comparison between an input sentence and an example is performed using the vector space method, the value of each element of vectors is represented not by tf but by tf×idf, where idf is a parameter called invert document frequency.

The value of idf for a word w, idf(w), is given by the following equation (3).

$$idf ( w ) = log \frac{P}{C ( w )} + offset \qquad ( 3 )$$

where P denotes the total number of examples, C(w) denotes the number of examples in which the word w appears, and offset is a constant. In equation (3), for example, 2 is used as the base of logarithm (log).

As can be seen from equation (3), idf(w) has a large value for words w that appear only in particular examples, that is, that represent the content (topic) of examples, but idf(w) has a small value for words w such as particles and auxiliary verbs that appear widely in many examples.

For example, when there are 1024 examples including a particle “wa” (a Japanese particle having no counterpart in English), C(wa) is given as 1024. Furthermore, if offset is equal to 1, the total number P of examples is 4096, and the number of occurrences of the particle “wa” in an example #p (or in an input sentence) is 2 (that is, tf=2), then, in a vector representing the example #p, the value of an element corresponding to the particle “wa” is 2 when tf is employed, and is 6 when tf×idf is employed.

Note that using tf×idf instead of tf as the value of vector element may be applied to input examples and an input sentence or may be applied only to input examples or an input sentence.

In the evaluation of matching performed by the practical response sentence generator 13, the method of increasing the contribution of a word representing the content of a sentence to the score is not limited to using of tf×idf, but the contribution may also be increased, for example, by setting values of elements of vectors representing an input sentence and examples such that elements corresponding to ancillary words such as particles and auxiliary verbs other than independent words such as nouns, verbs, and adjectives are set to 0.

In the above-described examples, the practical response sentence generator 13 produces a practical response sentence as a response to an input sentence, based on the input sentence and examples stored in the example database 14. In the production of the practical response sentence, the practical response sentence generator 13 may also refer to the dialogue log stored on the dialogue log database 15. A method of producing response sentence using also a dialogue log is described below. By way of example, in the following discussion, a process performed by the practical response sentence generator 13 to produce a practical response sentence is described. First, the dialogue log recorded in the dialogue log database 15 is described.

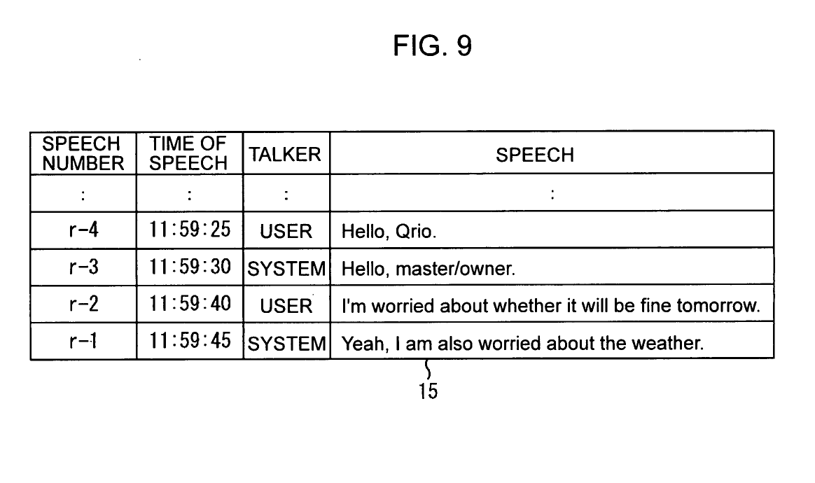

FIG. 9 shows an example of a dialogue log stored in the dialogue log database 15 shown in FIG. 2.

In the dialogue log database 15, speeches made between a user and the voice dialogue system shown in FIG. 1 are recorded, for example, such that each record (row) includes one speech (utterance). As described earlier, the dialogue log database 15 receives, from the response output controller 16, an input sentence obtained by performing speech recognition on a speech of a user and also receives a response sentence produced as a response to the input sentence. When the dialogue log database 15 receives the input sentence and the corresponding response sentence, the dialogue log database 15 records these sentences such that one record includes one speech.

In each record of the dialogue log database 15, in addition to a speech (an input sentence or a response sentence), a speech number that is a serial number assigned to each speech in the order of speech, a speech time indicating the time (or the date and time) of the speech, and a talker of the speech are also described.

If the initial value of the speech number is 1, then there are r−1 speeches with speech numbers from 1 to r−1 in the dialogue log in the example shown in FIG. 9. In this case, a next speech to be recorded in the dialogue log database 15 will have a speech number r.

The speech time for an input sentence indicates the time at which a speech recorded as the input sentence was made by a user. The speech time for a response sentence indicates the time at which the response sentence was output from the response output controller 16. In any case, the speech time is measured by a built-in clock (not shown) disposed in the voice dialogue system shown in FIG. 1.

In the field “talker” of each record of the dialogue log database 15, information indicating the talker of a speech is described. That is, for a record in which a speech made by a user is described as an input sentence, “user” is described in the talker field. For a record in which a response sentence is described, system” is described in the talker field to indicate that the speech is output by the voice dialogue system shown in FIG. 1.

In the dialogue log database 15, each record does not necessarily need to include information indicating the speech number, the speech time, and the talker. In the dialogue log database 15, it is desirable that input sentences and responses to the respective input sentences be recorded in the same order as the order in which speeches corresponding to the input sentences or responses were actually made.

In the production of practical response sentences, the practical response sentence generator 13 may also refer to the dialogue log stored on the dialogue log database 15 in addition to input sentences and examples stored in the example database 14.

A method of producing a practical response sentence based on the dialogue log is to use the latest speech recorded in the dialogue log. Another method producing a practical response sentence based on the dialogue log is to use the latest speech and a particular number of previous speeches recorded in the dialogue log.

Herein let us assume that the latest speech recorded in the dialogue log has a speech number r−1. Hereinafter, the speech with the speech number r−1 will be referred to simply as the speech #r−1.

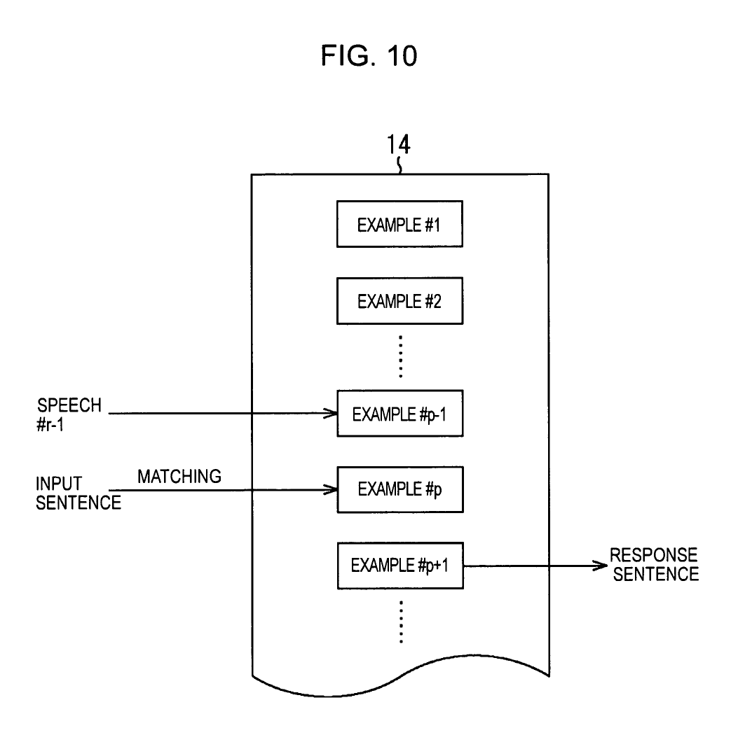

FIG. 10 shows a method of producing a practical response sentence based on the latest speech #r−1 recorded in the dialogue log.

In the case in which the practical response sentence generator 13 produces a practical response sentence based on the latest speech #r−1 recorded in the dialogue log, the practical response sentence generator 13 evaluates not only matching between an input sentence and an example #p stored in the example database 14 but also matching between a previous example #p−1 and the speech #r−1 recorded in the dialogue log, as shown in FIG. 10.

Let score (A, B) denote the score that indicates the similarity between two sentences A and B and that is calculated in the comparison process (for example, the score is given by cos θₖ determined according to equation (1)). The practical response sentence generator 13 determines the score, for the input sentence, of the example #p stored in the example database 14, for example, in accordance with the following equation (4).

$$\begin{matrix}Score of example \# p = score ( input sentence , example \# p ) + \\ α \times score ( {U}_{r - 1} , example \# p - 1 )\end{matrix} \qquad ( 4 )$$

where Uᵣ₋₁ denotes the speech #r−1 recorded in the dialogue log. In the example shown in FIG. 9, the speech #r−1 is a speech “Year, I am also worried about the weather” described in the bottom row (record). In equation (4), α denotes a weight (indicating the degree to which the speech #r−1 is taken into account) assigned to the speech #r−1. α is set to a proper value equal to or greater than 0. When α is set to be equal to 0, the score of the example #p is determined without taking into account the speech #r−1 recorded in the dialogue log.

The practical response sentence generator 13 performs the comparison process to determine the score according to equation (4) for each of examples #1, #2, . . . , #p−1, #p, #p+1 recorded in the example database 14. The practical response sentence generator 13 selects, from the example database 14, an example located at a position immediately following an example having a highest score or following an example selected from a plurality of examples having high scores, and the practical response sentence generator 13 employs the selected example as a practical response sentence to the input sentence. For example, in FIG. 10, if an example #p has the highest score according to equation (4), an example #p+1 located at the position following the example #p is selected and employed as the practical response sentence.

In equation (4), the total score for the example #p is given as the sum of score(input sentence, example #p) that is the score for the example #p with respect to the input sentence and αscore (Uᵣ₋₁, example #p−1) that is the score weighted by a factor α for the example #p−1 with respect to the speech #r−1 (Uᵣ₋₁). However, the determination of the total score is not limited to that according to equation (4), but the total score may be determined in other ways. For example, the total score may be given by an arbitrary monotonically increasing function of score(input sentence, example #p) and αscore(Uᵣ₋₁, example #p−1).

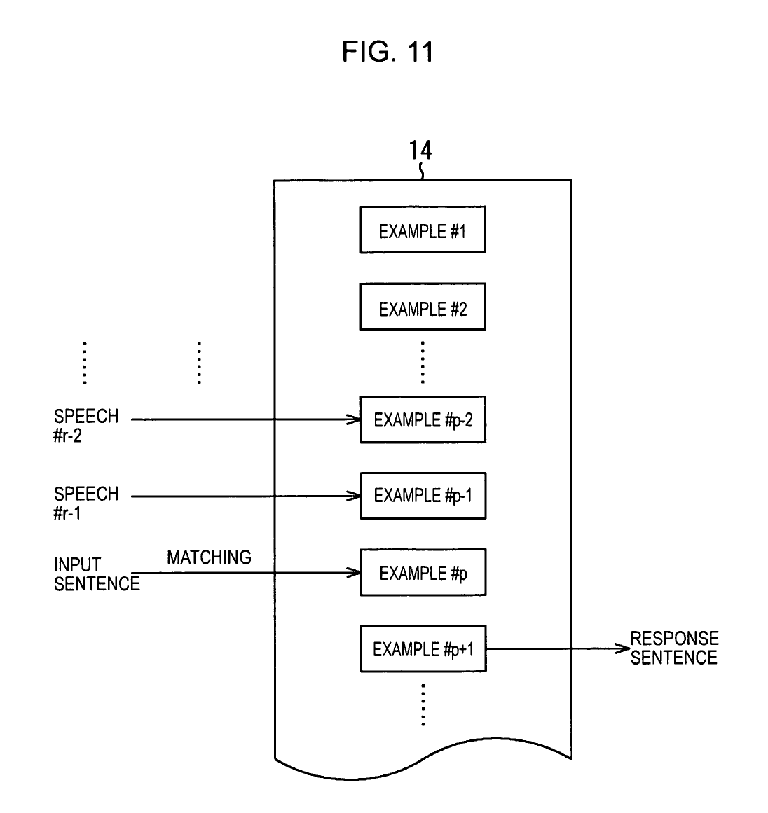

FIG. 11 shows a method of producing a practical response sentence using speeches including the latest speeches and an arbitrary number of previous speeches recorded in the dialogue log.

In the case in which the practical response sentence generator 13 produces a practical response sentence using D speeches including the latest speech #r−1 and previous speeches recorded in the dialogue log, that is, speeches #r−1, #r−2, . . . , #r−D, the practical response sentence generator 13 performs the comparison not only between the input sentence and the example #p recorded in the example database 14 but also between the speeches #r−1, #r−2, . . . , #r−D and respective T examples previous to the example #p, that is, examples #p−1, #p−2, . . . , #p−D.

More specifically, the practical response sentence generator 13 determines the score for the example #p recorded in the example database 14 with respect to the input sentence, for example, in accordance with the following equation (5).

$$Score for example \# p = {\sum }_{d = 0}^{D} f ( {t}_{r - d} ) \times score ( {u}_{r - d {,}_{example \# p - d}} ) \qquad ( 5 )$$

where t_{r-d} denotes the elapsed time from the time (speech time shown in FIG. 9) at which the speech #r−1 recorded in the dialogue log was made to the current time. Note that when d=0, tᵣ=0.

In equation (5), f(t) is a non-negative function that monotonically decreases with an argument t. The value of f(t) for t=0 is, for example, 1.

In equation (5), U_{r-d} denotes the speech #r−d recorded in the dialogue log. Note that when d=0, Uᵣ denotes the input sentence.

In equation (5), D is an integer that is equal to or greater than 0 and that is smaller than a smaller one of p and r.

The practical response sentence generator 13 performs the comparison process to determine the score according to equation (5) for each of examples #1, #2, . . . , #p−1, #p, #p+1 recorded in the example database 14. The practical response sentence generator 13 selects, from the example database 14, an example located at a position immediately following an example having a highest score or selects an example located at a position immediately following an example selected from a plurality of examples having high scores, and the practical response sentence generator 13 employs the selected example as a practical response sentence to the input sentence. For example, in FIG. 11, if an example #p has the highest score according to equation (5), an example #p+1 located at the position following the example #p is selected and employed as the practical response sentence.

According to equation (5), the total score for the example #p is given by the sum of the score of the example #p with respect to the input sentence Uᵣ, that is, score_(Uᵣ, example #p) weighted by a factor 1 (=f(0)) and the scores of previous example #p−d with respect to a speech #r−d, that is, score_(U_{r-d}, example #p−d) (d=1, 2, 3, . . . , D), weighted by a factor f(t_{r-d}, where the weight f(t_{r-d} decreases with the elapsed time t_{r-d} from the utterance of a speech #r−d U_{r-d} to the current time. In equation (5), when D is set to 0, the score of the example #p is determined without taking into account any speech recorded in the dialogue log.

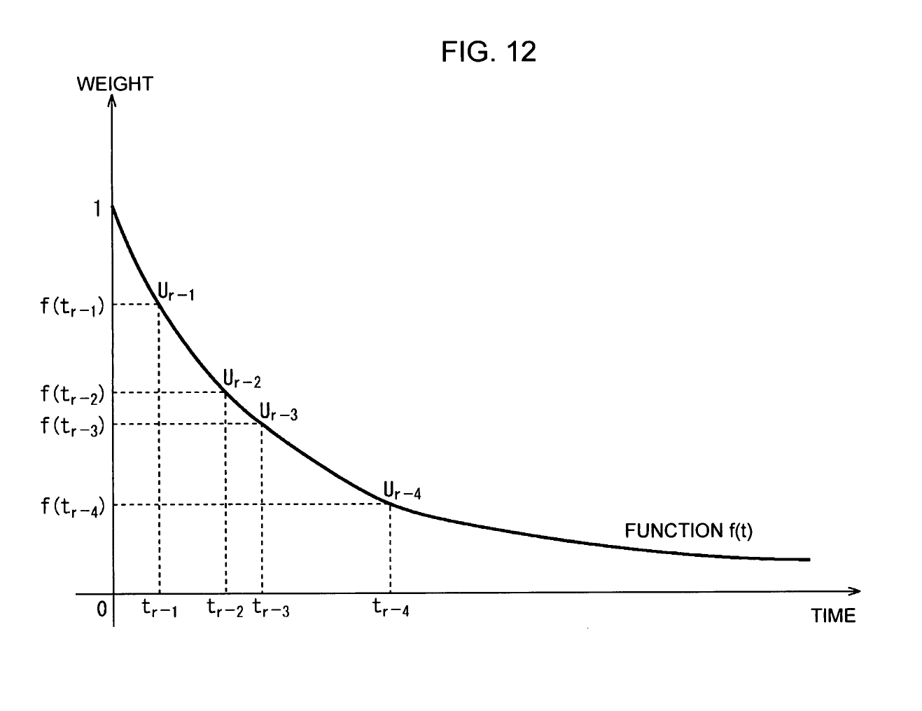

FIG. 12 shows an example of the function f(t) of a time t used in equation (5).

The function f(t) shown in FIG. 12 is determined in analogy to a so-called forgetting curve representing the tendency of decay of memory kept in mind. Note that in contrast to the forgetting curve that decreases at a slow rate, the function f(t) shown in FIG. 12 decreases at a high rate.

As described above, by using also the dialogue log in the production of a practical response sentence, it becomes possible to calculate the score such that when a user utters the same speech as the past speech and thus the same input sentence as the past input sentence is given, an example different from an example used as a response to the past input sentence gets a higher score than the example used as the response to the past input sentence thereby returning a response sentence different from a past response sentence.

Furthermore, it becomes also possible to prevent a sudden change in topic of a response sentence, which would give an unnatural impression to a user.

By way of example, let us assume that examples about talks made during a travel and examples obtained by editing talks made in a talk show are recorded in the example database 14. In this situation, when an example output the previous time is one of the examples about talks made during the travel, if one of the examples obtained by editing talks made during the talk show is employed as a practical response sentence output this time, a user has an unnatural impression because of a sudden change in topic.

The above problem can be avoided by calculating the score associated with matching according to equation (4) or (5) such that the dialogue log is also used in the production of the practical response sentence, thereby preventing the practical response sentence from changing in topic.

More specifically, for example, when the practical response sentence output the previous time was produced from an example selected from the examples of the talk made during the travel, if the score is calculated according to equation (4) or (5), the score generally becomes higher for the examples of the talk made during the travel than for the examples obtained by editing the talk made in the talk show, and thus it is possible to prevent one of the examples obtained by editing the talk made in the talk show from being selected as the practical response sentence to be output this time.

When a user utters a speech representing a change in topic, such as “Not to change the subject” or the like, the response generator 4 (FIG. 2) may delete the dialogue log recorded in the dialogue log database 15 so that any previous input sentence or response sentence will no longer have an influence on following response sentences.

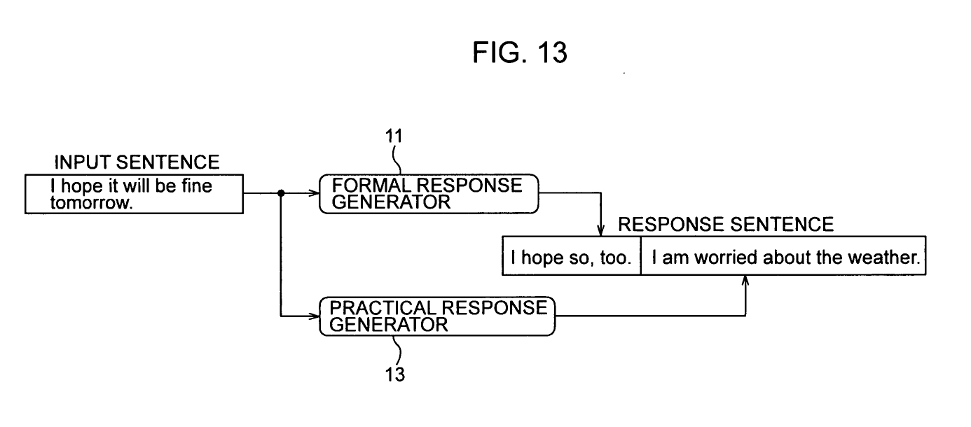

Referring to FIG. 13, a process performed by the response output controller 16 shown in FIG. 2 to control outputting of the formal response sentence and the practical response sentence is described below.

As described earlier, the response output controller 16 receives the formal response sentence from the formal response sentence generator 11 and the practical response sentence from the practical response sentence generator 13. The response output controller 16 combines the received formal response sentence and the practical response sentence into the form of a conclusive response to the input sentence, and the response output controller 16 outputs the resultant conclusive response sentence to the controller 3.

More specifically, for example, the response output controller 16 sequentially outputs the formal response sentence and the practical response sentence produced in response to the input sentence in this order thereby, as a result, outputting a concatenation of the formal response sentence and the practical response sentence as a conclusive response sentence.

More specifically, for example, as shown in FIG. 13, if “I hope it will be fine tomorrow” is supplied as an input sentence to the formal response sentence generator 11 and the practical response sentence generator 13, then the formal response sentence generator 11 produces, for example, a formal response sentence “I hope so, too” which is consistent in form with the input sentence “I hope it will be fine tomorrow”, and the practical response sentence generator 13 produces, for example, a practical response sentence “I'm also worried about the weather” which is consistent in content with the input sentence “I hope it will be fine tomorrow”. Furthermore, the formal response sentence generator 11 supplies the formal response sentence “I hope so, too” to the response output controller 16, and the practical response sentence generator 13 supplies the practical response sentence “I hope it will be fine tomorrow”.

In this case, the response output controller 16 supplies the formal response sentence “I hope so, too” received from the formal response sentence generator 11 and the practical response sentence “I hope it will be fine tomorrow” received from the practical response sentence generator 13 to the speech synthesizer 5 (FIG. 1) via the controller 3 in the same order as the order in which they were received. The speech synthesizer 5 sequentially synthesizes voices of the formal response sentence “I hope so, too” and the practical response sentence “I hope it will be fine tomorrow”. As a result, the synthesized voice “I hope so, too. I hope it will be fine tomorrow” is output from the speaker 6 as a conclusive response to the input sentence “I hope it will be fine tomorrow”.

In the example described above with reference to FIG. 13, the response output controller 16 sequentially outputs the formal response sentence and the practical response sentence produced in response to the input sentence in this order thereby outputting the conclusive response sentence in the form of a concatenation of the formal response sentence and the practical response sentence. Alternatively, the response output controller 16 may output the formal response sentence and the practical response sentence in a reverse order thereby outputting a conclusive response sentence in the form of a reverse-order concatenation of the formal response sentence and the practical response sentence.

The determination as to which one of the formal response sentence and the practical response sentence should be output first may be made, for example, based on a response score indicating the degree of appropriateness as a response to the input sentence. More specifically, the response score is determined for each of the formal response sentence and the practical response sentence, and one with a higher score is output first and the other having a lower score is output next.

Alternatively, the response output controller 16 may output only one of the formal response sentence and the practical response sentence, which got a higher score, as a conclusive response sentence.

The response output controller 16 may output the formal response sentence and/or the practical response sentence such that when the scores of the formal response sentence and the practical response sentence are both higher than a predetermined threshold value, both the formal response sentence and the practical response sentence are output in the normal or reverse order, while when only one of the formal response sentence and the practical response sentence is higher than the predetermined threshold value, only one of the formal response sentence and the practical response sentence, which is higher in score than the other, is output. In a case in which the scores of the formal response sentence and the practical response sentence are both lower than the predetermined threshold value, a predetermined sentence such as a sentence indicating that the voice dialogue system cannot understand what the user said or a sentence to request the user to say again in a different way, may be output as a conclusive response sentence without outputting the formal response sentence and the practical response sentence.

The response score may be given by a score determined based on the degree of matching between an input sentence and examples.

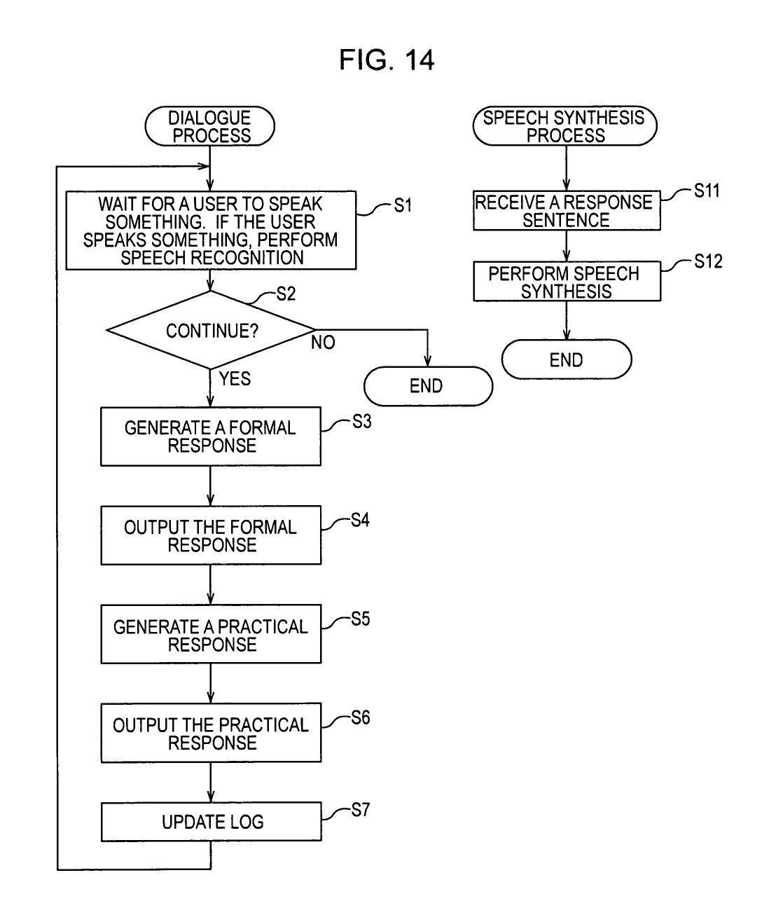

Now, referring to a flow chart shown in FIG. 14, the operation of the voice dialogue system shown in FIG. 1 is described.

In this operation shown in FIG. 14, the response output controller 16 sequentially outputs a formal response sentence and a practical response sentence in this order such that a normal-order concatenation of the formal response sentence and the practical response sentence is output as a conclusive response to an input sentence.

The process performed by the voice dialogue system mainly includes a dialogue process and a speech synthesis process.

In the first step S1 in the dialogue process, the speech recognizer 2 waits for a user to say something. If the user says something, the speech recognizer 2 performs speech recognition on a voice input via the microphone 1.

In a case in which the user says nothing for a time with a length equal to or greater than a predetermined value, the voice dialogue system may output a synthesized voice of a message such as “Please say something” from the speaker 6 to prompt the user to say something or may display such a message on a display (not shown).

If, in step S1, the speech recognizer 2 performs speech recognition on the voice uttered by the user and input via the microphone 1, the speech recognizer 2 supplies, as an input sentence, a speech recognition result in the form of a series of words to the controller 3.

The input sentence does not necessarily need to be given by the speech recognition, but the input sentence may be given in other ways. For example, a user may operate a keyboard or the like to input a sentence. In this case, the controller 3 divides the input sentence into words.

If the controller 3 receives the input sentence, the controller 3 advances the process from step S1 to step S2. In step S2, the controller 3 analyzes the input sentence to determine whether the dialogue process should be ended.

If it is determined in step S2 that the dialogue process should not be ended, the controller 3 supplies the input sentence to the formal response sentence generator 11 and the practical response sentence generator 13 in the response generator 4 (FIG. 2). Thereafter, the controller 3 advances the process to step S3.

In step S3, the formal response sentence generator 11 produces a formal response sentence in response to the input sentence and supplies the resultant formal response sentence to the response output controller 16. Thereafter, the process proceeds to step S4. More specifically, for example, when “I hope it will be fine tomorrow” is given as an input sentence, if “I hope so, too” is produced as a formal response sentence to the input sentence, this formal response sentence is supplied from the formal response sentence generator 11 to the response output controller 16.

In step S4, the response output controller 16 outputs the formal response sentence received from the formal response sentence generator 11 to the speech synthesizer 5 via the controller 3 (FIG. 1). Thereafter, the process proceeds to step S5.

In step S5, the practical response sentence generator 13 produces a practical response sentence in response to the input sentence and supplies the resultant practical response sentence to the response output controller 16. Thereafter, the process proceeds to step S6. More specifically, for example, when “I hope it will be fine tomorrow” is given as an input sentence, if “I'm also worried about the weather” is produced as a practical response sentence to the input sentence, this practical response sentence is supplied from the practical response sentence generator 13 to the response output controller 16.

In step S6, after the outputting of the formal response sentence in step S4, the response output controller 16 outputs the practical response sentence received from the practical response sentence generator 13 to the speech synthesizer 5 via the controller 3 (FIG. 1). Thereafter, the process proceeds to step S7.

That is, as shown in FIG. 14, the response output controller 16 outputs the formal response sentence received from the formal response sentence generator 11 to the speech synthesizer 5, and then, following the formal response sentence, the response output controller 16 outputs the practical response sentence received from the practical response sentence generator 13 to the speech synthesizer 5. In the present example, “I hope so, too” is produced as the formal response sentence and “I'm also worried about the weather” is produced as the practical response sentence, and thus, a sentence obtained by connecting the practical response sentence to the end of the formal response sentence, that is, “I hope so, too. I'm also worried about the weather”, is output from the response output controller 16 to the speech synthesizer 5.

In step S7, the response output controller 16 updates the dialogue log recorded in the dialogue log database 15. Thereafter, the process returns to step S1, and the process is repeated from step S1.

More specifically, in step S7, the input sentence and the final response sentence output in response to the input sentence, that is, the normal-order concatenation of the formal response sentence and the practical response sentence, are supplied to the dialogue log database 15. If the speech with a speech number of r−1 is the latest speech recorded in the dialogue log database 15, then the dialogue log database 15 records the input sentence supplied from the response output controller 16 as a speech with a speech number of r and also records the conclusive response sentence supplied from the response output controller 16 as a speech with a speech number of r+1.

More specifically, for example, when “I hope it will be fine tomorrow” is given as an input sentence, and “I hope so, too. I'm also worried about the weather” is output as a final response sentence produced by connecting the practical response sentence to the end of the formal response sentence, the input sentence “I hope it will be fine tomorrow” is recorded as the speech with the speech number of r in the dialogue log database 15, and the conclusive response sentence “I hope so, too. I'm also worried about the weather” is further recorded as the speech with the speech number of r+1.

On the other hand, in the case in which it is determined in step S2 that the dialogue process should be ended, that is, in the case in which a sentence such as “Let's end our talk” or a similar sentence indicating the end of the talk is given as the input sentence, the dialogue process is ended.

In the dialogue process, as described above, a formal response sentence is produced in step S3 in response to an input sentence, and this formal response sentence is output in step S4 from the response output controller 16 to the speech synthesizer 5. Furthermore, in step S5, a practical response sentence to the input sentence is produced, and this practical response sentence is output in step S6 from the response output controller 16 to the speech synthesizer 5.

If the formal response sentence or the practical response sentence is output from the response output controller 16 in the dialogue process, then the speech synthesizer 5 (FIG. 1)>starts the speech synthesis process. Note that the speech synthesis process is performed concurrently with the dialogue process.

In the first step S11 in the speech synthesis process, the speech synthesizer 5 receives the formal response sentence or the practical response sentence output from the response output controller 16. Thereafter, the process proceeds to step S12.

In step S12, the speech synthesizer 5 performs speech synthesis in accordance with the data of the formal response sentence or the practical response sentence received in step S11 to synthesize a voice corresponding to the formal response sentence or the practical response sentence. The resultant voice is output from the speaker 6 (FIG. 1). If the outputting of the voice is completed, the speech synthesis process is ended.

In the dialogue process, as described above, the formal response sentence is output in step S4 from the response output controller 16 to the speech synthesizer 5, and, thereafter, in step S6, the practical response sentence is output from the response output controller 16 to the speech synthesizer 5. In the speech synthesis process, as described above, each time a response sentence is received, a voice corresponding to the received response sentence is synthesized and output.

More specifically, in the case in which “I hope so, too” is produced as the formal response sentence and “I'm also worried about the weather” is produced as the practical response sentence, the formal response sentence “I hope so, too” and the practical response sentence “I'm also worried about the weather” are output in this order from the response output controller 16 to the speech synthesizer 5. The speech synthesizer 5 synthesizes voices corresponding to the formal response sentence “I hope so, too” and the practical response sentence “I'm also worried about the weather” in this order. As a result, a synthesized voice “I hope so, too. I'm also worried about the weather” is output from the speaker 6.

In a case in which the dialogue process and the speech synthesis process cannot be performed in parallel, the speech synthesizer 5 performs, in a step between steps S4 and S5 in the dialogue process, the speech synthesis process associated with the formal response sentence output in step S4 from the response output controller 16, and performs, in a step between steps S6 and S7 in the dialogue process, the speech synthesis process associated with the practical response sentence output in step S6 from the response output controller 16.

In the present embodiment, as described above, the formal response sentence generator 11 and the practical response sentence generator 13 are provided separately, and the formal response sentence and the practical response sentence are produced respectively by the formal response sentence generator 11 and the practical response sentence generator 13 in the above-described manner. Thus, it is possible to obtain a formal response sentence consistent in form with an input sentence and it is also possible to obtain a practical response sentence consistent in content with the input sentence. Furthermore, the outputting of the formal response sentence and the practical response sentence is controlled by the response output controller 16 such that a conclusive response sentence consistent in both form and content with the input sentence is output. This can cause a user to have the impression that the system understands what the user talks.

Furthermore, because the production of the formal response sentence by the formal response sentence generator 11 and the production of the practical response sentence by the practical response sentence generator 13 are performed independently, if the speech synthesizer 5 is capable of performing the speech synthesis associated with the formal response sentence or the practical response sentence output from the response output controller 16 concurrently with the process performed by the formal response sentence generator 11 or the practical response sentence generator 13, then the practical response sentence generator 13 can produce the practical response sentence while the synthesized voice of the formal response sentence produced by the formal response sentence generator 11 is output. This makes it possible to reduce the response time from the time at which an input sentence is given by a user to the time at which the outputting of a response sentence is started.

When the formal response sentence generator 11 and the practical response sentence generator 13 respectively produce a formal response sentence and a practical response sentence based on examples, it is not necessary to prepare a large number of examples for use in the production of the formal response sentence, which depends on words determining the form of an input sentence (that is, which is consistent in form with the input sentence), compared to examples for use in the production of the practical response sentence, which depends on words representing a content (a topic) of the input sentence.

In view of the above, the ratio of the number of examples for use in the production of a formal response sentence and the number of examples for use in the production of a practical response sentence is set to, for example, 1:9. Herein, for simplicity of the following explanation, let us assume that the time needed to produce a response sentence is simply proportional to the number of examples used in the production of the response sentence. In this case, the time needed to produce a formal response sentence is one-tenth the time needed to produce a response sentence based on the examples prepared for use in the production of the formal response sentence and the examples prepared for use in the production of the practical response sentence. Therefore, if the formal response sentence is output immediately after the production of the formal response sentence is completed, the response time can be reduced to one-tenth the time needed to output the formal response sentence and the practical response sentence after the production of both the formal response sentence and the practical response sentence is completed.

This makes it possible to respond to input sentences in real time or very quickly in dialogues.

In a case in which the speech synthesizer 5 cannot perform speech recognition on the formal response sentence or the practical response sentence output from the response output controller 16 in parallel with the process performed by the formal response sentence generator 11 or the practical response sentence generator 13, when the production of the formal response sentence by the formal response sentence generator 11 is completed, the speech synthesizer 5 performs speech recognition on the formal response sentence, and thereafter, when the production of the practical response sentence by the practical response sentence generator 13 is completed, the speech synthesizer 5 performs speech recognition on the practical response sentence. Alternatively, after the formal response sentence and the practical response sentence are sequentially produced, the speech synthesizer 5 sequentially performs speech recognition on the formal response sentence and the practical response sentence.

Use of a dialogue log in addition to an input sentence and examples in the production of a practical response sentence not only makes it possible to prevent a sudden change in the content (the topic) of the practical response sentence, but also makes it possible to produce different practical response sentences for the same input sentence.

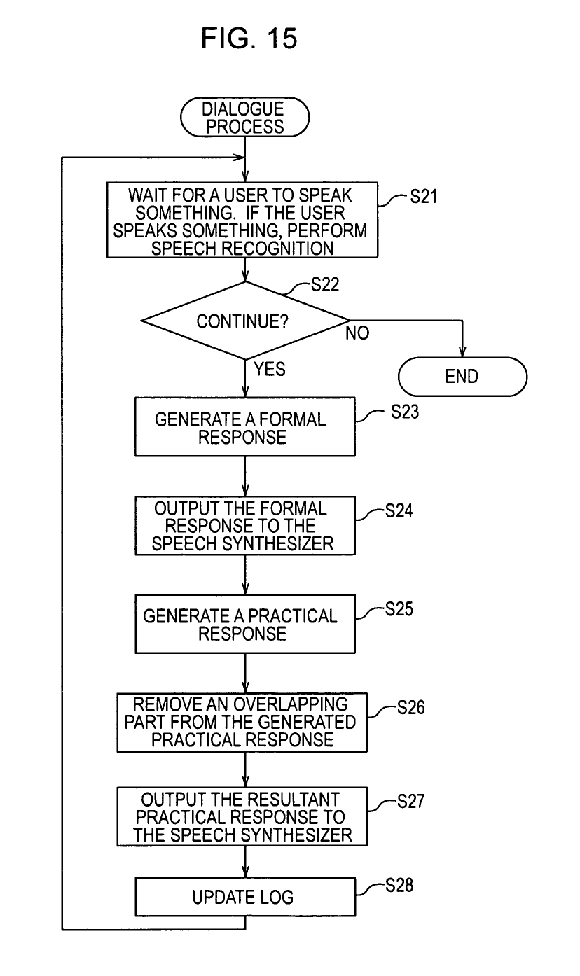

Now, referring to a flow chart shown in FIG. 15, a dialogue process performed by the voice dialogue system according to another embodiment of the invention is described below.

The dialogue process shown in FIG. 15 is similar to the dialogue process shown in FIG. 14 except for an additional step S26. That is, in the dialogue process shown in FIG. 15, steps S21 to S25 and steps S27 and 28 are respectively performed in a similar manner to steps S1 to S7 of the dialogue process shown in FIG. 14. However, the dialogue process shown in FIG. 15 is different from the dialogue process shown in FIG. 14 in that, after step S25 corresponding to step S5 in FIG. 14 is completed, step S26 is performed, and thereafter, step S27 corresponding to step S6 in FIG. 14 is performed.

That is, in the dialogue process shown in FIG. 15, in step S21 as in step S1 shown in FIG. 14, the speech recognizer 2 waits for a user to say something. If something is said by the user, the speech recognizer 2 performs speech recognition to detect what is said by the user, and the speech recognizer 2 supplies, as an input sentence, the speech recognition result in the form of a series of words to the controller 3. If the controller 3 receives the input sentence, the controller 3 advances the process from step S21 to step S22. In step S22 as in step S2 shown in FIG. 14, the controller 3 analyzes the input sentence to determine whether the dialogue process should be ended. If it is determined in step S22 that the dialogue process should be ended, the dialogue process is ended.

If it is determined in step S22 that the dialogue process should not be ended, the controller 3 supplies the input sentence to the formal response sentence generator 11 and the practical response sentence generator 13 in the response generator 4 (FIG. 2). Thereafter, the controller 3 advances the process to step S23. In step S23, the formal response sentence generator 11 produces a formal response sentence in response to the input sentence and supplies the resultant formal response sentence to the response output controller 16. Thereafter, the process proceeds to step S24.

In step S24, the response output controller 16 outputs the formal response sentence received from the formal response sentence generator 11 to the speech synthesizer 5 via the controller 3 (FIG. 1). Thereafter, the process proceeds to step S25. In response, as described earlier with reference to FIG. 14, the speech synthesizer 5 performs the speech synthesis associated with the formal response sentence.

In step S25, the practical response sentence generator 13 produces a practical response sentence in response to the input sentence and supplies the resultant practical response sentence to the response output controller 16. The process then proceeds to step S26.

In step S26, the response output controller 16 determines whether the practical response sentence received from the practical response sentence generator 13 overlaps the formal response sentence output in immediately previous step S24 to the speech synthesizer 5 (FIG. 1), that is, whether the practical response sentence received from the practical response sentence generator 13 includes the formal response sentence output in immediately previous step S24 to the speech synthesizer 5. If the practical response sentence includes the formal response sentence, the same portion of the practical response sentence as the formal response sentence is removed from the practical response sentence.

More specifically, for example, when the formal response sentence is “Yes.” and the practical response sentence is “Yes, I'm also worried about the weather”, if the dialogue process is performed in accordance with the flow shown in FIG. 14, then “Yes. Yes, I'm also worried about the weather.” is output as the conclusive response, which is a simple connection of the practical response sentence and the formal response sentence. As a result of simply connecting the practical response sentence and the formal response sentence, “Yes” is duplicated in the conclusive response.

In the dialogue process, to avoid the above problem, in step S26, it is checked whether the practical response sentence supplied from the practical response sentence generator 13 includes the formal response sentence output in immediately previous step S24 to the speech synthesizer 5. If the practical response sentence includes the formal response sentence, the same portion of the practical response sentence as the formal response sentence is removed from the practical response sentence. More specifically, in the case in which the formal response sentence is “Yes.” and the practical response sentence is “Yes, I'm also worried about the weather”, the practical response sentence “Yes, I'm also worried about the weather” includes a portion that is the same as the formal response sentence “Yes”, and thus this same portion “Yes” is removed from the practical response sentence. Thus, the practical response sentence is modified as “I'm also worried about the weather”.

In a case in which the practical response sentence does not include the entire formal response sentence, but the practical response sentence and the formal response sentence partially overlap each other, an overlapping portion may be removed from the practical response sentence in step S26 described above. For example, when the formal response sentence is “Yes, indeed” and the practical response sentence is “Indeed, I'm also worried about the weather”, the formal response sentence “Yes, indeed” is not completely included in the practical response sentence “Indeed, I'm also worried about the weather”, but the last portion “indeed” of the formal response sentence is identical to the first portion “Indeed” of the practical response sentence. Thus, in step S26, the overlapping portion “Indeed” is removed from the practical response sentence “Indeed, I'm also worried about the weather”. As a result, the practical response sentence is modified as “I'm also worried about the weather”.

When the practical response sentence includes no portion overlapping the formal response sentence, the practical response sentence is maintained without being subjected to any modification in step S26.

After step S26, the process proceeds to step S27, in which the response output controller 16 outputs the practical response sentence received from the practical response sentence generator 13 to the speech synthesizer 5 via the controller 3 (FIG. 1). Thereafter, the process proceeds to step S28. In step S28, as in step S7 in FIG. 14, the response output controller 16 updates the dialogue log by additionally recording the input sentence and the conclusive response sentence output in response to the input sentence in the dialogue log of the dialogue log database 15. Thereafter, the process returns to step S21, and the process is repeated from step S21.

In the dialogue process shown in FIG. 15, as described above, in step S26, a part, which is identical to a part or the whole of the formal response sentence, of the practical response sentence is removed from the practical response sentence, and the resultant practical response sentence no longer including an overlapping part is output to the speech synthesizer 5. This prevents outputting an unnatural synthesized speech (response) including duplicated parts such as “Yes. Yes, I'm also worried about the weather” or “Yes, indeed. Indeed, I'm also worried about the weather”.

More specifically, for example, when the formal response sentence is “Yes.” and the practical response sentence is “Yes, I'm also worried about the weather”, if the dialogue process is performed in accordance with the flow shown in FIG. 14, then “Yes. Yes, I'm also worried about the weather.” is output as the conclusive response, which is a simple connection of the practical response sentence and the formal response sentence. As a result of simply connecting the practical response sentence and the formal response sentence, “Yes” is duplicated in the conclusive response. When the formal response sentence is “Yes, indeed” and the practical response sentence is “Indeed, I'm also worried about the weather”, the dialogue process in accordance with the flow shown in FIG. 14 would produce “Yes, indeed. Indeed, I'm also worried about the weather” as the conclusive response, in which “indeed” is duplicated.

In contrast, in the dialogue process shown in FIG. 15, it is checked whether the practical response sentence includes a part (overlapping part) that is identical to a part or the whole of the formal response sentence, and, if an overlapping part is detected, the overlapping part is removed from the practical response sentence. Thus, it is possible to prevent outputting an unnatural synthesized speech including a duplicated part.

More specifically, for example, when the formal response sentence is “Yes” and the practical response sentence is “Yes, I'm also worried about the weather” (including the whole of the formal response sentence “Yes”), the overlapping part “Yes” is removed, in step S26, from the practical response sentence “Yes, I'm also worried about the weather”. As a result, the practical response sentence is modified as “I'm also worried about the weather”. Thus, the resultant synthesized speech becomes “Yes, I'm also worried about the weather”, which is a concatenation of the formal response sentence “Yes” and the modified practical response sentence “I'm also worried about the weather” no longer including the overlapping part “Yes”.

When the formal response sentence is “Yes, indeed” and the practical response sentence is “Indeed, I'm also worried about the weather” (in which “Indeed” is a part overlapping the formal response sentence, the overlapping part “Indeed” is removed, in step S26, from the practical response sentence “Indeed, I'm also worried about the weather”. As a result, the practical response sentence is modified as “I'm also worried about the weather”. Thus, the resultant synthesized speech becomes “Yes, indeed, I'm also worried about the weather”, which is a concatenation of the formal response sentence “Yes, indeed” and the modified practical response sentence “I'm also worried about the weather” no longer including the overlapping part “Indeed”.

When the formal response sentence and the practical response sentence include an overlapping part, the overlapping part may be removed not from the practical response sentence but from the formal response sentence. However, in the dialogue process shown in FIG. 15, because the removal of the overlapping part is performed in step S26 after the formal response sentence has already been output, in step S24, from the response output controller 16 to the speech synthesizer 5, it is impossible to remove the overlapping part from the formal response sentence.

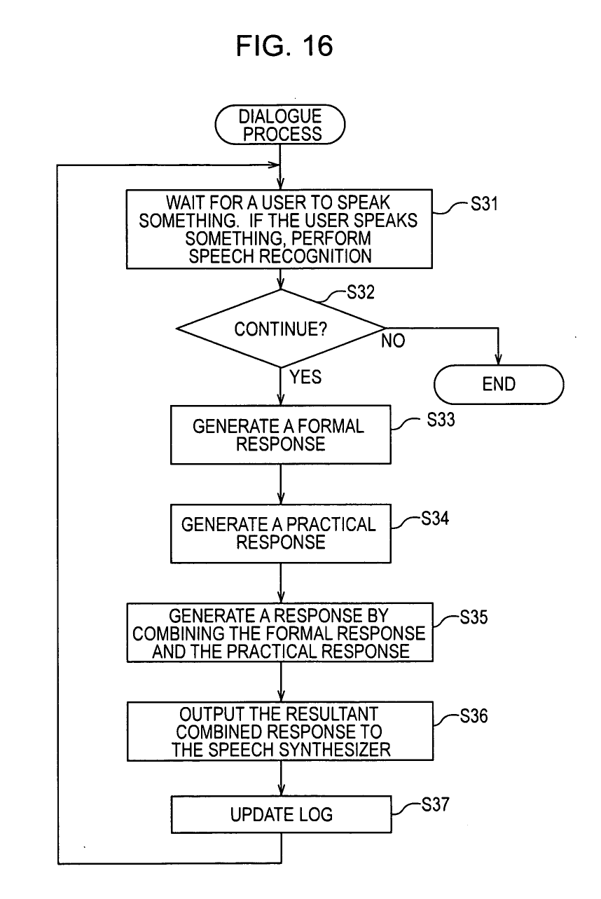

To make it possible to remove the overlapping part from the formal response sentence, the dialogue process is modified as shown in a flow chart of FIG. 16.

In the dialogue process shown in FIG. 16, in step S31 as in step S1 shown in FIG. 14, the speech recognizer 2 waits for a user to say something. If something is said by the user, the speech recognizer 2 performs speech recognition to detect what is said by the user, and the speech recognizer 2 supplies, as an input sentence, the speech recognition result in the form of a series of words to the controller 3. If the controller 3 receives the input sentence, the controller 3 advances the process from step S31 to step S32. In step S32 as in step S2 shown in FIG. 14, the controller 3 analyzes the input sentence to determine whether the dialogue process should be ended. If it is determined in step S32 that the dialogue process should be ended, the dialogue process is ended.

If it is determined in step S32 that the dialogue process should not be ended, the controller 3 supplies the input sentence to the formal response sentence generator 11 and the practical response sentence generator 13 in the response generator 4 (FIG. 2). Thereafter, the controller 3 advances the process to step S33. In step S33, the formal response sentence generator 11 produces a formal response sentence in response to the input sentence and supplies the resultant formal response sentence to the response output controller 16. Thereafter, the process proceeds to step S34.

In step S34, the practical response sentence generator 13 produces a practical response sentence in response to the input sentence and supplies the resultant practical response sentence to the response output controller 16. Thereafter, the process proceeds to step S35.

Note that steps S33 and S34 may be performed in parallel.

In step S35, the response output controller 16 produces a final sentence as a response to the input sentence by combining the formal response sentence produced in step S33 by the formal response sentence generator 11 and the practical response sentence produced in step S34 by the practical response sentence generator 13. Thereafter, the process proceeds to step S36. The details of the process performed in step S35 to combine the formal response sentence and the practical response sentence will be described later.

In step S36, the response output controller 16 outputs the conclusive response sentence produced in step S35 by combining the formal response sentence and the practical response sentence to the speech synthesizer 5 via the controller 3 (FIG. 1). Thereafter, the process proceeds to step S37. The speech synthesizer 5 performs speech synthesis, in a similar manner to the speech synthesis process described earlier with reference to FIG. 14, to produce a voice corresponding to the conclusive response sentence supplied from the response output controller 16.

In step S37, the response output controller 16 updates the dialogue log by additionally recording the input sentence and the conclusive response sentence output as a response to the input sentence in the dialogue log of the dialogue log database 15, in a similar manner to step S7 in FIG. 14. Thereafter, the process returns to step S31, and the process is repeated from step S31.

In the dialogue process shown in FIG. 16, the conclusive response sentence to the input sentence is produced in step S35 by combining the formal response sentence and the practical response sentence according to one of first to third methods described below.

In the first method, the conclusive response sentence is produced by combining the practical response sentence to the end of the formal response sentence or combining the formal response sentence to the end of the practical response sentence.

In the second method, it is checked whether the formal response sentence and the practical response sentence satisfy a predetermined condition, as will be described in further details later with reference to a sixth modification.

In the second method, when both the formal response sentence and the practical response sentence satisfy the predetermined condition, the conclusive response sentence is produced by combining the practical response sentence to the end of the formal response sentence or combining the formal response sentence to the end of the practical response sentence, as in the first method. On the other hand, when only one of the formal response sentence and the practical response sentence satisfies the predetermined condition, the formal response sentence or the practical response sentence satisfying the predetermined condition is employed as the conclusive response sentence. In a case in which neither the formal response sentence nor the practical response sentence satisfies the predetermined condition, a sentence “I have no good answer” or a similar sentence is employed as the conclusive response sentence.

In third method, the conclusive response sentence is produced from the formal response sentence and the practical response sentence by using a technique, known in the art of the machine translation, of producing a sentence from a result of a phrase-by-phrase translation.

In the first method or the second method, when the formal response sentence and the practical response sentence are connected, an overlapping part between the formal response sentence and the practical response sentence may be removed in the process of producing the conclusive response sentence, as in the dialogue process shown in FIG. 15.

In the dialogue process shown in FIG. 16, as described above, after the formal response sentence and the practical response sentence are combined, the resultant sentence is output as the conclusive response sentence from the response output controller 16 to the speech synthesizer 5. Therefore, it is possible to remove an overlapping part from either one of the formal response sentence and the practical response sentence.

In the case in which the formal response sentence and the practical response sentence include an overlapping part, instead of removing the overlapping part from the formal response sentence or the practical response sentence, the response output controller 16 may ignore the formal response sentence and may simply output only the practical response sentence as the conclusive response sentence.

By ignoring the formal response sentence and simply outputting only the practical response sentence as the conclusive response sentence, it is also possible to prevent a synthesized speech from including an unnatural duplicated part, as described above with reference to FIG. 15.

More specifically, for example, when the formal response sentence is “Yes” and the practical response sentence is “Yes, I'm also worried about the weather”, if the formal response sentence is ignored and only the practical response sentence is output as the conclusive response sentence, then “Yes, I'm also worried about the weather” is output as the conclusive response sentence. In this specific example, if, instead, the formal response sentence “Yes” and the practical response sentence “Yes, I'm also worried about the weather” are simply connected in this order, then the resultant conclusive response sentence is “Yes. Yes, I'm also worried about the weather” which includes an unnatural duplicated word “Yes”. Such an unnatural expression is prevented by ignoring the formal response sentence.

When the formal response sentence is “Yes, indeed” and the practical response sentence is “Indeed, I'm also worried about the weather”, if the formal response sentence is ignored and only the practical response sentence is output as the conclusive response sentence, then “Yes, indeed. I'm also worried about the weather” is output as the conclusive response sentence. In this specific example, if, instead, the formal response sentence “Yes, indeed” and the practical response sentence “Indeed, I'm also worried about the weather” are simply connected in this order, then the resultant conclusive response sentence is “Yes, indeed. Indeed, I'm also worried about the weather” which includes an unnatural duplicated word “indeed”. Such an unnatural expression is prevented by ignoring the formal response sentence.

In the dialogue process shown in FIG. 16, after a formal response sentence and a practical response sentence are both produced, the response output controller 16 produces a conclusive response sentence by combining the formal response sentence and the practical response sentence, and the response output controller 16 outputs the conclusive response sentence to the speech synthesizer 5. Therefore, there is a possibility that the response time from the time at which an input sentence is given by a user to the time at which outputting of a response sentence is started becomes longer than the response time in the dialogue process shown in FIG. 14 or 15 in which the speech synthesis of the formal response sentence and the production of the practical response sentence are performed in parallel.

However, the dialogue process shown in FIG. 16 has the advantage that after the formal response sentence and the practical response sentence are both produced, the response output controller 16 combines the formal response sentence and the practical response sentence into the final form of the response sentence, it is possible to arbitrarily modify any one of or both of the formal response sentence and the practical response sentence in the combining process.

Now, first to tenth modifications to the voice dialogue system shown in FIG. 1 are described. First, the first to tenth modifications are very briefly described, thereafter, the details of each modification are described.

In the first modification, the comparison to determine the similarity of examples to an input sentence is performed using a DP (Dynamic Programming) matching method, instead of the vector space method. In the second modification, the practical response sentence generator 13 employs an example having a highest score as a practical response sentence instead of employing an example at a position following the example having the highest score. In the third modification, the voice dialogue system shown in FIG. 1 is characterized by employing only speeches made by a particular talker as examples used in production of a response sentence. In the fourth modification, in the calculation of the score of matching between an input sentence and examples, the scores is weighted depending on the group of examples so that an example relating to a current topic is preferentially selected as a response sentence. In the fifth modification, a response sentence is produced based on examples each including one or more variables. In the sixth modification, it is determined whether a formal response sentence or a practical response sentence satisfies a predetermined condition, and the formal response sentence or the practical response sentence satisfying the predetermined condition is output. In the seventh modification, the confidence measure for a speech recognition result is calculated, and a response sentence is produced taking into account the confidence measure. In the eighth modification, the dialogue log is also used as examples in production of a response sentence. In the ninth modified embodiment, a response sentence is determined based on the likelihood (the score indicating the likelihood) of each of N best speech recognition candidates and also based on the score of matching between each example and each speech recognition candidate. In the tenth modification, a formal response sentence is produced depending on the acoustic feature of a speech made by a user.

The first to tenth modifications are described in further detail below.

First Modification

In the first modification, in the comparison process performed by practical response sentence generator 13 to determine the similarity of examples to an input sentence, the DP (Dynamic Programming) matching method is used instead of the vector space method.

The DP matching method is widely used to calculate the measure of the distance between two patterns that are different in the number of elements (different in length) from each other, while taking into account the correspondence between similar elements of respective patterns.

An input sentence and the examples are in the form of series of elements where elements are words. Thus, the DP matching method can be used to calculate the measure of the distance between an input sentence and an example while taking into account the correspondence between similar words included in the input sentence and the example.

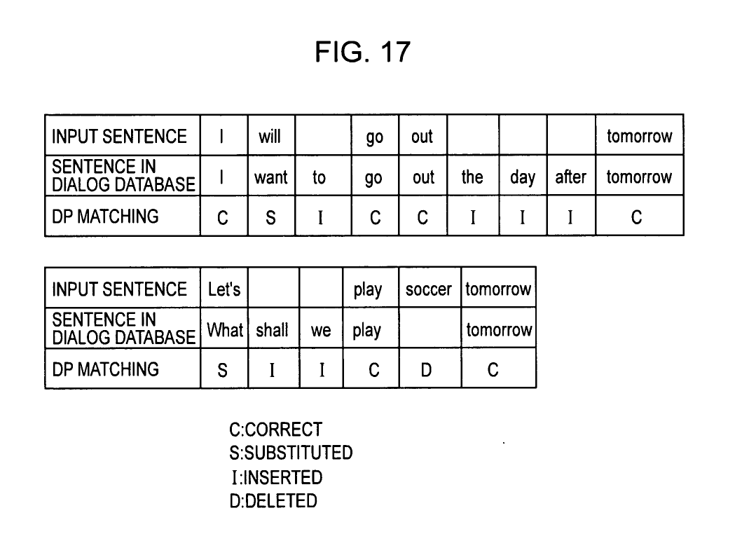

Referring to FIG. 17, the process of evaluation matching between an input sentence and examples based on the DP matching method is described below.

FIG. 17 shows examples of DP matching between an input sentence and an example.

On the upper side of FIG. 17, shown is an example of a result of DP matching between an input sentence “I will go out tomorrow” and an example “I want to go out the day after tomorrow”. On the lower side of FIG. 17, shown is an example of a result of DP matching between an input sentence “Let's play soccer tomorrow” and an example “What shall we play tomorrow?”.

In the DP matching, each word in an input sentence is compared with a counterpart in an example while maintaining the order of words, and the correspondence between each word and the counterpart is evaluated.

There are four types of correspondence: correct correspondence (C), substitution (S), insertion (I), and deletion (D).

The correct correspondence C refers to an exact match between a word in the input sentence and a counterpart in the example. The substitution S refers to a correspondence in which a word in the input sentence and a counterpart in the example are different from each other. The insertion I refers to a correspondence in which the input sentence includes no word corresponding to a word in the example (that is, the example includes an additional word that is not included in the input sentence). The deletion D refers to a correspondence in which the example includes no counterpart corresponding to a word in the input sentence (that is, the example lacks a word included in the input sentence).

Each pair of corresponding words is marked one of symbols C, S, I, and D to indicate the correspondence determined by the DP matching. If a symbol other than C is marked for a particular pair of corresponding words, that is, if one of S, I, and D is marked, there is some difference (in words or in the order of words) between the input sentence and the example.

In the case in which the matching between an input sentence and an example is evaluated by the DP matching method, weights are assigned to each word of the input sentence and the example to represent how significant each word is in the matching. 1 may be assigned as the weight to all words, or weights assigned to respective words may be different from each other.

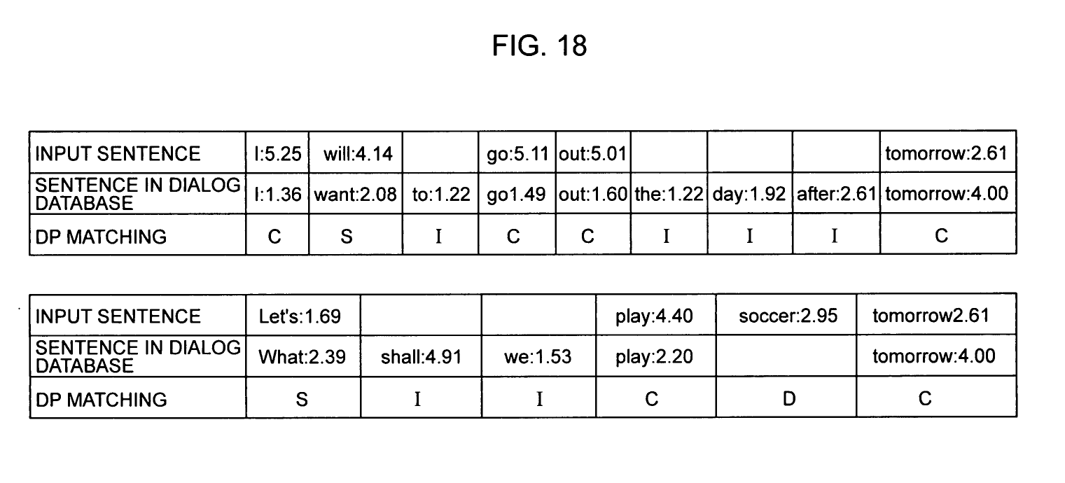

FIG. 18 shows examples of results of DP matching between input sentences and examples which are similar to those shown in FIG. 17 except that weights assigned to respective words of the input sentences and the examples.

On the upper side of FIG. 18, shown is an example of a result of DP matching between an input sentence and an example which are similar to those shown on the upper side of FIG. 17, wherein weights are assigned to respective words of the input sentence and the example. On the lower side of FIG. 18, shown is an example of a result of DP matching between an input sentence and an example which are similar to those shown on the lower side of FIG. 17, wherein weights are assigned to respective words of the input sentence and the example.

In FIG. 18, a numeral following a colon located at the end of each word of the input sentence and the example denotes a weight assigned to the word.

In the matching process performed by the formal response sentence generator 11, in order to properly produce a formal response sentence, great weights should be assigned to particles, auxiliary verbs, or similar words that determine the form of a sentence. On the other hand, in the matching process performed by the practical response sentence generator 13, in order to properly produce a practical response sentence, great weights should be assigned to words representing the content (topic) of a sentence.

Thus, in the matching process performed by the formal response sentence generator 11, it is desirable that weights for words of an input sentence be given, for example, by df, and weights for words of an example be set to be equal to 1. On the other hand, in the matching process performed by the practical response sentence generator 13, it is desirable that weights for words of an input sentence be given, for example, by idf, and weights for words of an example be set to be equal to 1.

However, In FIG. 18, for the purpose of illustration, weights for words of input sentences are given by df, and weights for words of examples are given by idf.

When the matching between an input sentence and an example is evaluated, it is needed to introduce an evaluation measure indicating how similar an input sentence and an example are with respect to each other (or how different they are from each other).

In the matching process in the speech recognition, evaluation measures called correctness and accuracy are known. In the matching process in the text searching, an evaluation measure called precision is known.

Herein, an evaluation measure for use in the matching process between an input sentence and an example using the DP matching method is introduced on the analogy of correctness, accuracy and precision.

The evaluation measures correctness, accuracy, and precision are respectively given by equations (6) to (8).

$$\begin{matrix}correctness = \frac{{C}_{i}}{{C}_{i} + {S}_{i} + {D}_{i}} & ( 6 ) \\ accuracy = \{ \begin{matrix}\frac{{C}_{o} - {I}_{o}}{{C}_{i} + {S}_{i} + {D}_{i}} \times \frac{{C}_{i}}{{C}_{o}} \\ - \frac{{I}_{o}}{{S}_{i} + {D}_{i}} ( for {C}_{i} = {C}_{o} = 0 )\end{matrix} & ( 7 ) \\ precision = \frac{{C}_{o}}{{C}_{o} + {S}_{o} + {I}_{o}} & ( 8 )\end{matrix}$$

In equations (6) to (8), C_{I} denotes the sum of weights assigned to words of the input sentence evaluated as C (correct) in the correspondence, S_{I} denotes the sum of weights assigned to words of the input sentence evaluated as S (substitution) in the correspondence, D_{I} denotes the sum of weights assigned to words of the input sentence evaluated as D (deletion) in the correspondence, Cₒ denotes the sum of weights assigned to words of the example evaluated as C (correct) in the correspondence, Sₒ denotes the sum of weights assigned to words of the example evaluated as S (substitution) in the correspondence, and Iₒ denotes the sum of weights assigned to words of the example evaluated as I (insertion) in the correspondence.

When weights are set to be equal to 1 for all words, C_{I} is equal to the number of words evaluated as C (correct) in the input sentence, S_{I} is equal to the number of words evaluated as S (substitution) in the input sentence, D_{I} is equal to the number of words evaluated as D (deletion) in the input sentence, Cₒ is equal to the number of words evaluated as C (correct) in the example, Sₒ is equal to the number of words evaluated as S (substitution) in the example, and Iₒ is equal to the number of words evaluated as I (insertion) in the example.

In the example associated with the DP matching shown on the upper side of FIG. 18, C_{I}, S_{I}, D_{I}, Cₒ, Sₒ, and Iₒ are calculated according to equation (9), and thus correction, accuracy and precision are given by equation (10).
C_{I}=5.25+5.11+5.01+2.61=17.98
S_{I}=4.14
D_{I}=0
Cₒ=1.36+1.49+1.60+4.00=8.45
Sₒ=2.08 (9)
correctness=81.3 (%)
accuracy=14.2 (%)
precision=48.3 (%) (10)

In the example associated with the DP matching shown on the lower side of FIG. 18, C_{I}, S_{I}, D_{I}, Cₒ, Sₒ, and Iₒ are calculated according to equation (11), and thus correction, accuracy and precision are given by equation (12).
Cᵢ=4.40+2.61=7.01
S_{I}=1.69
D_{I}=2.95
Cₒ=2.20+4.00=6.2
Sₒ=2.39
Iₒ=4.91+1.53=6.44 (11)
correctness=60.2 (%)
accuracy=−2.3 (%)
precision=41.3 (%) (12)

Any one of three evaluation measures correctness, accuracy, and precision may be used as the score indicating the similarity between an input sentence and an example. However, as described above, it is desirable that weights for words of an example be set to be equal to 1, weights for words of an input sentence in the matching process performed by the formal response sentence generator 11 be given by df, and weights for words of the input sentence in the matching process performed by the practical response sentence generator 13 be given by idf. In this case, it is desirable that, of correctness, accuracy, and precision, accuracy be used as the score indicating the similarity between an input sentence and an example. This allows the formal response sentence generator 11 to evaluate matching such that the similarity of the form of sentences is greatly reflected in the score, and also allows the practical response sentence generator 13 to evaluate matching such that the similarity of words representing contents of sentences is greatly reflected in the score.

When the evaluation measure “accuracy” is used as the score indicating the similarity between an input sentence and an example, the score approaches 1.0 with increasing similarity between the input sentence and the example.

In the matching between an input sentence and an example according to the vector space method, the similarity between the input sentence and the example is regarded to be high when the similarity between words included in the input sentence and words included in the example is high. On the other hand, in the matching between an input sentence and an example according to the DP matching method, the similarity between the input sentence and the example is regarded to be high when not only the similarity words included in the input sentence and words included in the example is high but also the similarity in terms of the order of words and the length of sentences (the numbers of words included in the respective sentences) is high. Thus, use of the DP matching method makes it possible to more strictly evaluate the similarity between an input sentence and an example than can be by the vector space method.

In the case in which idf given by equation (3) is used as weights for words of an input sentence, idf cannot be determined when C(w)=0, because equation (3) makes no sense for C(w)=0.

C(w) in equation (3) represents the number of examples in which a word w appears. Therefore, if a word in an input sentence is not included in any example, C(w) for that word becomes equal to 0. In this case, idf cannot be determined according to equation (3) (this situation occurs when an unknown word is included in an input sentence, and thus this problem is called an unknown-word problem).

When C(w) for a word w in an input sentence is equal to 0, the above-described problem with that word is avoided by one of two methods described below.

In a first method, when C(w)=0 for a particular word w, the weight for this word w is set to be equal to 0 so that this word w (unknown word) is ignored in the matching.

In a second method, when C(w)=0 for a particular word w, C(w) is replaced by 1 or a non-zero value within a range from 0 to 1, and idf is calculated according to equation (3) such that a large weight is given in the matching.

The calculation of correctness, accuracy, or precision as the score indicating the similarity between an input sentence and an example may be performed during the DP matching process. More specifically, for example, when accuracy is employed as the score indicating the similarity between an input sentence and an example, counterparts of one of the input sentence and the example for respective words of the other one of correspondences between words of the input sentence and words of the example, that is, counterparts of one of the input sentence and the example for respective words of the other one of, are determined such that the accuracy has a maximum value, and it is determined which one of correspondence types C (correct), S (substitution), I (insertion) and D (deletion) each word has.

In the DP matching, the correspondences between words of the input sentence and words of the example may be determined such that the number of determination types other than C (correct), that is, the number of determination types S (substitution), I (insertion), and D (deletion) is minimized. The calculation of correctness, accuracy, or precision used as the soccer indicating the similarity between the input sentence and the example may be performed after the determination is made as to which one of correspondence types C (correct), S (substitution), I (insertion), and D (deletion) each word of the input sentence and the example has.

Instead of using one of the correctness, accuracy and precision as the score indicating the similarity between an input sentence and an example, a value determined as a function of one or more of the correctness, accuracy and precision may also be used.

Although the DP matching method allows it to more strictly evaluate the similarity between an input sentence and an example than can be by the matching based on the vector space method, the DP matching method needs a greater amount of computation and a longer computation time. To avoid the above problem, the matching between an input sentence and an example may be evaluated using both the vector space method and the DP matching method as follows. First, the matching is evaluated using the vector space method for all examples, and a plurality number of examples evaluated as most similar to the input sentence are selected. Subsequently, these selected examples are further evaluated in terms of the matching using the DP matching method. This method makes it possible to perform the matching evaluation in a shorter time than is needed in the DP matching method.

In the production of a formal response sentence or a practical response sentence, the formal response sentence generator 11 and the practical response sentence generator 13 may perform the matching evaluation using the same method or different methods.

For example, the formal response sentence generator 11 may perform the matching evaluation using the DP matching method, and the practical response sentence generator 13 may perform the matching evaluation using the vector space method. Alternatively, the formal response sentence generator 11 may perform the matching evaluation using a combination of the vector space method and the DP matching method, while the practical response sentence generator 13 may perform the matching evaluation using the vector space method.

Second Modification

In the second modification, the practical response sentence generator 13 employs an example having a highest score as a practical response sentence, instead of employing an example located at a position following the example having the highest score.

In the previous embodiments or examples, in the production of a practical response sentence by the practical response sentence generator 13, as described above with reference to FIG. 8, 10, or 11, for example, if an example #p has a highest score in terms of the similarity to an input sentence, an example #p+1 following the example #p is employed as the practical response sentence. Instead, the example #p having the highest score may be employed as the practical response sentence.

However, when the example #p having the highest score is completely identical to the input sentence, if the example #p is employed as the practical response sentence, the practical response sentence identical to the input sentence is output as a response to the input sentence. This gives an unnatural impression to a user.

To avoid the above problem, when the example #p having the highest score is identical to the input sentence, an example having a highest score is selected from examples that are different from the input sentence, and the selected example is employed as the practical response sentence. In this case, an example that is similar but not completely identical to the input sentence is employed as the practical response sentence.

In the case in which an example having a highest score is employed as a practical response sentence, examples recorded in the example database 14 (FIG. 2) do not necessarily need to be examples based on actual dialogs, but examples based on monologues such as novels, diaries, or newspaper articles may also be used.

In general, it is easier to collect examples of monologues than examples of dialogues. Thus, when an example having a highest score is employed as a practical response sentence, it is allowed to use examples of monologues as examples recorded in the example database 14, and it becomes easy to build the example database 14.

It is allowed to record both examples of dialogues and examples of monologues in the example database 14. More specifically, for example, examples of dialogues may be recorded in an example database 14_{J}, and examples of monologues may be recorded in another example database 14_{j′}. In this case, when a certain example gets a highest score, if it is an example recorded in the example database 14_{J} in which examples of dialogues are recorded, then an example located at a position following this example may be employed as a practical response sentence. Conversely, if the example having the highest score is an example recorded in the example database 14_{j′} in which examples of monologues are recorded, this example may be employed as the practical response sentence.

In examples of monologues, an example is not necessarily a response to an immediately previous example. Therefore, it is not appropriate to calculate the score of matching between an input sentence and examples in a similar manner to manners described above with reference to FIG. 10 or 11 in which matching between an input sentence and examples included in a log of talks between a user and the voice dialogue system is evaluated (wherein the examples recorded in the dialogue log database 15 (FIG. 2)) according to equation (4) or (5).

On the other hand, use of a dialogue log in the matching process between an input sentence and examples makes it possible to maintain a current topic of a conversation, that is, it becomes possible to prevent a sudden change in content of a response sentence, which would give an unnatural feeling to a user.

However, when examples of monologues are used as examples, it is not appropriate to use a dialogue log in the matching process, and thus there occurs a problem as to how to maintain a current topic of a conversation. A method of maintain a current topic of a conversation without using a dialogue log in the matching process between an input sentence and examples will be given in a description of a fourth modification.

In the second modification, as described above, in the process performed by the practical response sentence generator 13, when an example of a monologue gets a highest score in the matching with an input sentence, if this example is identical to the input sentence, this example is rejected to prevent the same sentence as the input sentence from being output as a response, but another example is selected which has a highest score of examples different from the input sentence, and the selected example is employed as the practical response sentence. Note that this method may also be applied to a case in which an example located at a position following an example that got a highest score in the evaluation of matching between an input sentence and examples is employed as a practical response sentence.

That is, in the voice dialogue system, if a response sentence is the same as a previous response sentence, a user will have an unnatural feeling.

To avoid the above problem, the practical response sentence generator 13 selects an example that is located at a position following an example evaluated as being similar to an input sentence and that is different from a previous response sentence, and the practical response sentence generator 13 employs the selected example as a practical response sentence to be output this time. That is, of examples different from the example employed as the previous practical response sentence, an example having a highest score is selected, and an example located in position following the example having the highest score is employed as a practical response sentence to be output this time.

Third Modification

In the third embodiment, the voice dialogue system shown in FIG. 1 is characterized by employing only speeches made by particular talkers as examples used in production of a response sentence.

In previous embodiments or modifications, the practical response sentence generator 13 selects an example following an example having a high score and employs the selected example as a practical response sentence, without taking into account the talker of the example employed as the practical response sentence.

For example, when the voice dialogue system shown in FIG. 1 is expected to play the role of a particular character such as a reservation desk clerk of a hotel, the voice dialogue system does not always output a response appropriate as the reservation desk clerk.

To avoid the above problem, when not only examples but also talkers of the respective examples are recorded in the example database 14 (FIG. 2) as in the example shown in FIG. 7, the practical response sentence generator 13 may take into account the talkers of the examples in the production of a practical response sentence.

For example, when examples such as those shown in FIG. 7 are recorded in the example database 14, if the practical response sentence generator 13 preferentially employs examples whose talker is “reservation desk clerk” as practical response sentences, then the voice dialogue system plays the role of a reservation desk clerk of a hotel.

More specifically, un the example shown in FIG. 7, examples (with example numbers 1, 3, 5, . . . ) of speeches of the “reservation desk clerk” and examples (with example numbers 2, 4, 6, . . . ) of speeches of a customer (an applicant for reservation) are recorded in the order of speeches. Thus, when the algorithm of producing practical response sentences is set such that an example following an example having a highest score is employed as a practical response sentence, if a large score is given to each example immediately before each example of a speech of the “reservation desk clerk”, that is, if large scores are given to examples of speeches of the “customer”, examples of a speech of the “reservation desk clerk” are preferentially selected as practical response sentences.

To give large scores to examples of speeches of the customer, for example, it is determined whether an example being subjected to the calculation of the score indicating the similarity to an input sentence is an example of a speech of the “customer”, and, if it is determined that the example is of a speech of the “customer”, a predetermined offset value is added to the score for the example or the score is multiplied by a predetermined factor.

The calculation of the score in the above-described manner results in an increase in the probability that the practical response sentence generator 13 selects an example following an example of a speech of the “customer”, that is, an example of a speech of the “reservation desk clerk”, as a practical response sentence. Thus, a voice dialogue system capable of playing the role of a reservation desk clerk is achieved.

The voice dialogue system may include an operation control unit for selecting an arbitrary character from a plurality of characters such that examples corresponding to the character selected by operating the operation control unit are preferentially employed as practical response sentences.

Fourth Modification

In the fourth modification, the calculation the score in the evaluation of matching between an input sentence and an example is not performed according to equation (4) or (5) but performed such that examples are grouped and weights are assigned to respective groups of examples so that examples relating to a current topic are preferentially selected as response sentences.

For the above purpose, for example, examples are properly grouped and the examples are recorded in units of groups in the example database 14 (FIG. 2).

More specifically, for example, when examples rewritten based on a TV talk show or the like are recorded in the example database 14, the examples are grouped depending on, for example, the date of broadcasting, talkers, or topics, and the examples are recorded in units of groups in the example database 14.

Thus, let us assume that groups of examples are respectively recorded in example databases 14₁, 14₂, . . . , 14_{J}, that is, a particular group of examples is recorded in a certain example database 14_{J}, and another group of examples is recorded in another example database 14_{j′}.

Each example database 14_{J} in which a group of examples is recorded may be in the form of a file or may be stored in a part of a file such that the part is identifiable by a tag or the like.

By recording a particular group of examples in a certain example database 14_{J} in the above-described manner, the example database 14_{J} is characterized by the content of the topic of the group of examples recorded in this example database 14_{J}. The topic that characterizes the example database 14_{J} can be represented by a vector explained earlier in the description of the vector space method.

For example, when there are P different words in the examples recorded in the example database 14_{J} (wherein when the same word appears a plurality of times in the examples, the number of such words is counted as one), if a vector having P elements is given such that the P elements correspond to respective P words and such that the value of an i-th element indicates the number of occurrences of an i-th word, then the vector indicates the topic that characterizes the example database 14_{J}.

Herein, if such a vector characterizing each example database 14_{J} is referred to as a topic vector, then topic vectors of the respective example databases 14 can be plotted in a topic space whose each axis represents one of elements of topic vectors.

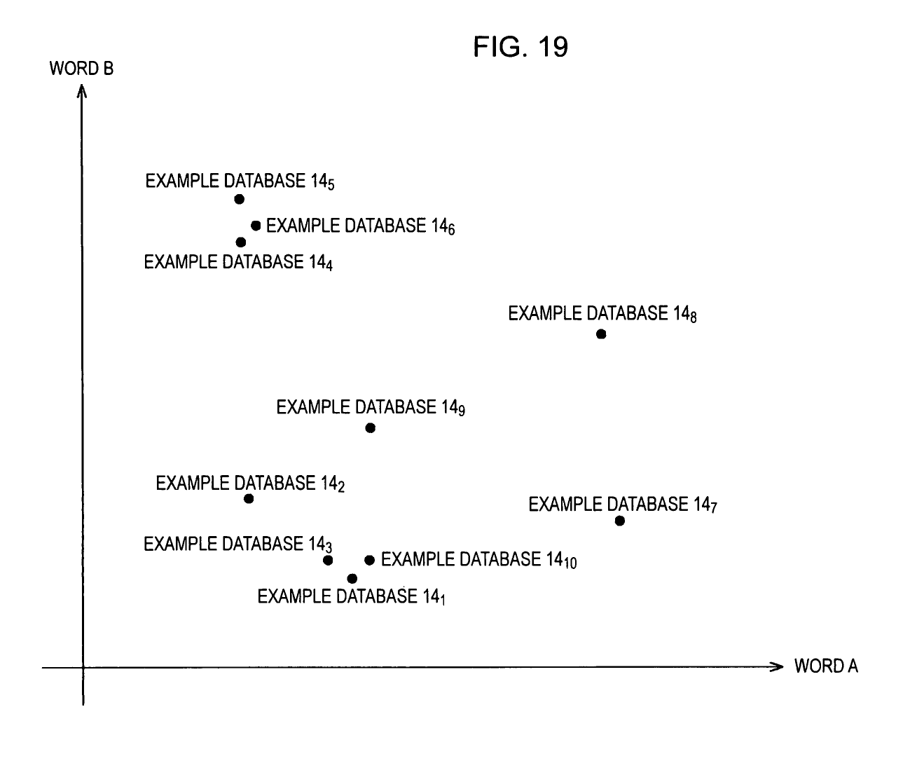

FIG. 19 shows an example of a topic space. In this example shown in FIG. 19, for simplicity, it as assumed that the topic space is a two-dimension space defined by two axes: word An axis; and word B axis.

As shown in FIG. 19, the topic vectors (end points of the respective topic vectors) of the respective example databases 14₁, 14₂, . . . , 14_{J} can be plotted in the topic space.

The measure indicating similarity (or the distance) between a topic characterizing an example database 14_{J} and a topic characterizing another example database 14_{j′} may be given, as in the vector space method, by cosine of the angle between the topic vector characterizing the example database 14_{J} and the topic characterizing the example database 14_{j′}, or may be given by the distance between the topic vectors (the distance between end points of the topic vectors).

The similarity between the topic of the group of examples recorded in the example database 14_{J} and the topic of the group of examples recorded in the example database 14_{j′}becomes high with increasing cosine of the angle between the topic vector representing the topic characterizing the example database 14_{J} and the topic vector representing the topic characterizing the example database 14_{j′}, or the similarity becomes high with decreasing distance between these topic vectors.

For example, in FIG. 19, example databases 14₁, 14₃, and 14₁₀ are close, in topic vectors, to each other and thus, the topics of examples recorded in the example databases 14₁, 14₃, and 14₁₀ are similar to each other.

In the present modified embodiment, as described above, the practical response sentence generator 13 produces a practical response sentence such that when the matching between an input sentence and examples is evaluated, examples to be compared with the input sentence are selected from a group of examples that are similar in terms of topic with an example employed in a previous practical response sentence, that is, in the calculation of the score indicating the similarity between the input sentence and examples, weights are assigned to respective groups of examples depending on the topics of the respective groups of examples such that a group of examples whose topic is similar to a current topic gets a greater score than other groups, thereby causing an increase in the probability that an example of such a group is selected as a practical response sentence and thus making it possible to maintain the current topic.

More specifically, for example, in FIG. 19, if an example employed as a previous output practical response sentence is one of examples recorded in the example database 14₁, then examples recorded in the example database 14₃ or 14₁₀, whose topic or topic vector is close to the topic or the topic vector of the example database 14₁, are highly likely to be similar in topic to the example employed as the previous practical response sentence.

Conversely, examples recorded in example databases whose topic vector is not close to that of the example database 14₁, such as example databases 14₄ to 14₈, are likely to be different in topic from the example employed as the previous practical response sentence.

Thus, in order to preferentially select an example, whose topic is similar to the current topic, as a next practical response sentence, the practical response sentence generator 13 calculates the score indicating the similarity between the input sentence and an example #p in accordance with, for example, the following equation (13).
score of example #p=f_{—}score(file(Uᵣ₋₁, file(example #p))×score(input sentence, example #p) (13)
where Uᵣ₋₁, denotes the example employed as the previous practical response sentence, file(Uᵣ₋₁) denotes an example database 14 in which the example Uᵣ₋₁ is recorded, file(example #p) denotes an example database 14 in which the example #p_is recorded, f_score(file(Uᵣ₋₁), file(example #p)) denotes the similarity between a group of examples recorded in the example database 14 in which the example Uᵣ₋₁ and a group of examples recorded in the example database 14 in which the example #p is recorded. The similarity between different groups of examples may be given, for example, by the cosine of the angle in the topic space between topic vectors. In equation (13), score(input sentence, example #p) denotes the similarity (score) between the input sentence and the example #p, wherein the similarity may be determined, for example, by the vector space method or the DP matching method.

By calculating the score indicating the similarity between the input sentence and the example #p according to equation (13), it becomes possible to prevent a sudden change in the topic without having to use a dialogue log.

Fifth Modification

In the fifth modified embodiment, examples recorded in an example database 14 may include one or more variables, and the practical response sentence generator 13 produces a practical response sentence from an example including one or more variables.

More specifically, words of a particular category, such as a word replaceable with a user name, a word replaceable with a current date/time, or the like, are detected from examples recorded in the example database 14, and the detected words are rewritten into the form of variables representing the category of words.

In the example database 14, a word replaceable with a user name is rewritten, for example, as a variable USER_NAME, a word replaceable with the current time is rewritten, for example, as a variable TIME, a word replaceable with the current date is rewritten, for example, as a variable DATE, and so on.

In the voice dialogue system, the name of a user, who talks with the voice dialogue system, is registered, and the variable USER_NAME is replaced with the registered user name. The variables TIME and DATE are respectively replaced with the current time and the current date. Similar replacement rules are predetermined for all variables.

For example, in the practical response sentence generator 13, if an example located at a position following an example that got a highest score is, is an example including a variable, such as Mr. USER_NAME, today is DATE”, then the variables USER_NAME and DATE included in this example “Mr. USER_NAME, today is DATE” are replaced in accordance with the predetermined rule, and the resultant example is employed as a practical response sentence.

For example, in the voice dialogue system, if “Sato” is registered as the user name, and the current date is January 1, then the example “Mr. USER_NAME, today is DATE” in the present example is replaced into Mr. Sato, today is January 1”, and the result is employed as the practical response sentence.

As described above, in the present modified embodiment, examples recorded in the example database 14 are allowed to include one or more variables, and the practical response sentence generator 13 replaces variables according to the predetermined rules in the process of producing a practical response sentence. This makes it possible to acquire a wide variety of practical response sentences even when the example database 14 include only a rather small number of examples.

When each example recorded in the example database 14 is described in the form of a set of an input example and a corresponding response example as with the example database 12 shown in FIG. 3, if a word of a particular category is included in both an input example and a corresponding response example of a particular set, the word included in each expression is replaced in advance with a variable representing the category of the word. In this case, in the practical response sentence generator 13, the word of the particular category included in an input sentence is replaced with the variable representing the category of the word, and the resultant input sentence is compared with an input example in the matching process. The practical response sentence generator 13 selects a response example coupled with an input example that gets a highest score in the matching process, and the practical response sentence generator 13 replaces the variable included in the response example with the original word replaced with the variable included in the input sentence. The resultant response example is employed as the practical response sentence.

More specifically, for example, when a set of an input example “My name is Taro Sato” and a corresponding response example “Oh, you are Mr. Taro Sato” is recorded in the example database 14, a word (words) belonging to a category of person's names is replaced with a variable $PERSON_NAME$ representing the category of person's names. In this specific example, words “Taro Sato” included in both the input example “My name is Taro Sato” and the corresponding response example “Oh, you are Mr. Taro Sato” are replaced with the variable $PERSON_NAME$ representing the category of person's names. As a result, the set of the input example “My name is Taro Sato” and the corresponding response example “Oh, you are Mr. Taro Sato” is converted into a set of an input example “My name is $PERSON_NAME$” and a response example “Oh, you are Mr. $PERSON_NAME$”.

In this situation, if “My name is Suzuki” is given as an input sentence, the practical response sentence generator 13 replaces the word “Suzuki” belonging to the category of person's names included in the input sentence “My name is Suzuki” with the variable $PERSON_NAME$ representing the category of person's names, and the practical response sentence generator 13 evaluates matching between the resultant input sentence “My name is $PERSON_NAME$” and input examples. If the above-described input example “My name is $PERSON_NAME$” gets a highest score in the evaluation of matching, the practical response sentence generator 13 selects the response example “Oh, you are Mr. $PERSON_NAME$” coupled with the input example “My name is “PERSON_NAME$”. Furthermore, the practical response sentence generator 13 replaces the variable $PERSON_NAME$ included in the response example “Oh, you are Mr. $PERSON_NAME$” with the original name “Suzuki” which was included in the original input sentence “My name is Suzuki” and was replaced with the $PERSON_NAME$. As a result, “Oh, you are Mr. Suzuki” is obtained as the model response sentence, and this is employed as the practical response sentence.

Sixth Modification

In the sixth modified embodiment, in the response output controller 16 (FIG. 2), a formal response sentence or a practical response sentence are not directly output to the speech synthesizer 5 (FIG. 1), but it is determined whether the formal response sentence or the practical response sentence satisfies a predetermined condition, and the formal response sentence or the practical response sentence is output to the speech synthesizer 5 (FIG. 1) only when the predetermined condition is satisfied.

In the case in which an example located at a position following an example having a highest score in the matching between an input sentence and examples is directly employed as a formal response sentence or a practical response sentence, even if all examples have rather low scores, that is, even if there is no example that is suitable as a response to th input sentence, an example located at a position following an example having a highest score of examples having low scores is employed as a formal response sentence or a practical response sentence.

In some cases, an example having a very large length (a very large number of words) or, conversely, an example having a very small length is not a proper example for use as a formal response sentence or a practical response sentence.

In order to prevent such an unsuitable example from being employed as a formal response sentence or a practical response sentence and finally outputting, the response output controller 16 determines whether the formal response sentence or the practical response sentence satisfies a predetermined condition and outputs the formal response sentence or the practical response sentence to the speech synthesizer 5 (FIG. 1) only when the predetermined condition is satisfied.

The predetermined condition may be a requirement for the example to get a score greater than a predetermined threshold value and/or a requirement that the number of words included in the example (the length of the example) be within a range of C1 to C2 (C1<C2).

The predetermined condition may be defined in common or separately for both the formal response sentence and the practical response sentence.

That is, in this sixth modified embodiment, the response output controller 16 (FIG. 2) determines whether the formal response sentence and the practical response sentence generator 13 supplied from the formal response sentence generator 11 satisfy the predetermined condition, and outputs the formal response sentence or the practical response sentence generator 13 to the speech synthesizer 5 (FIG. 1) when the predetermined condition is satisfied.

Thus, in this sixth modified embodiment, one of the following four cases can occur: 1) both the formal response sentence and the practical response sentence satisfy the predetermined condition, and both are output to the speech synthesizer 5; 2) only the formal response sentence satisfies the predetermined condition and thus only the formal response sentence is output to the speech synthesizer 5; 3) only the practical response sentence satisfies the predetermined condition and thus only the practical response sentence is output to the speech synthesizer 5; and 4) neither the formal response sentence nor the practical response sentence satisfies the predetermined condition, and thus neither is output to the speech synthesizer 5.

In the fourth case of the first to fourth cases described above, because neither the formal response sentence nor the practical response sentence is output to the speech synthesizer 5, no response is given to a user. This causes the user to misunderstand that the voice dialogue system is failed. To avoid the above problem in the fourth case, the response output controller 16 may output, to the speech synthesizer 5, a sentence indicating that the voice dialogue system cannot understand what the user said or a sentence to request the user to say again in a different way, such as “I don't have a good answer”, or “Please say again in a different way”.

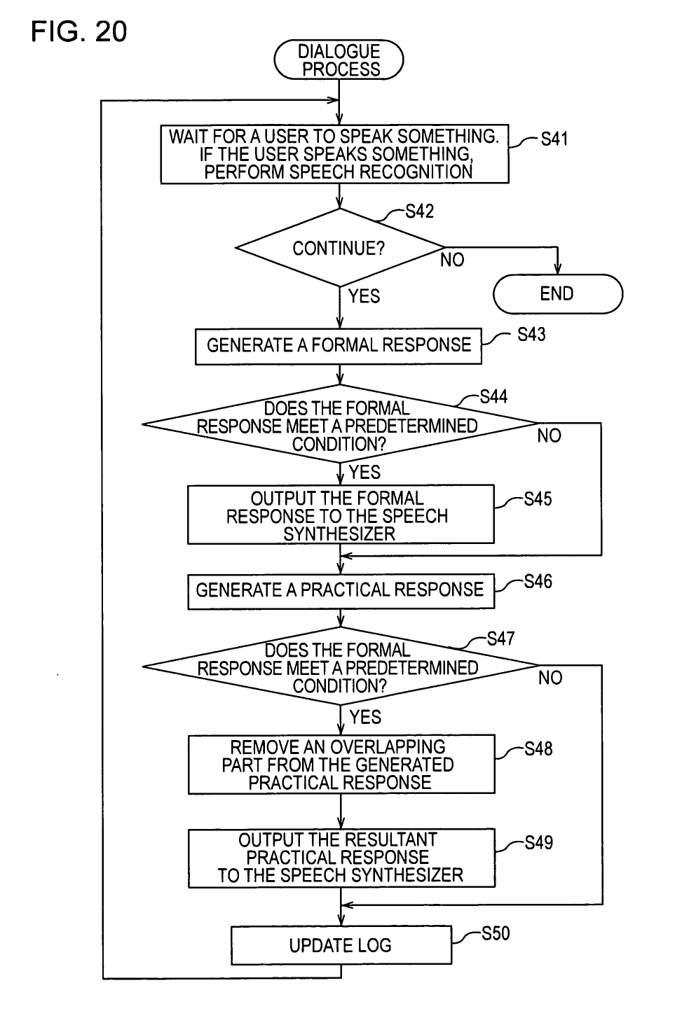

Referring to a flow chart shown in FIG. 20, the dialogue process according to the present modified embodiment is described, in which response output controller 16 determines whether a formal response sentence and a practical response sentence satisfy the predetermined condition and outputs the formal response sentence or the practical response sentence to the speech synthesizer 5 when the predetermined condition is satisfied.

In the dialogue process shown in FIG. 20, the dialogue process shown in FIG. 15 is modified such that it is determined whether a formal response sentence and a practical response sentence satisfy the predetermined condition, and the formal response sentence or the practical response sentence is output to the speech synthesizer 5 when the predetermined condition is satisfied. Note that a dialogue process according to another embodiment, such as the dialogue process described above with reference to the flow chart shown in FIG. 14, may also modified such that it is determined whether a formal response sentence and a practical response sentence satisfy the predetermined condition, and the formal response sentence or the practical response sentence is output to the speech synthesizer 5 when the predetermined condition is satisfied.

In the dialogue process shown in FIG. 20, in step S41 as in step S1 shown in FIG. 14, the speech recognizer 2 waits for a user to say something. If something is said by the user, the speech recognizer 2 performs speech recognition to detect what is said by the user, and the speech recognizer 2 supplies, as an input sentence, the speech recognition result in the form of a series of words to the controller 3. If the controller 3 receives the input sentence, the controller 3 advances the process from step S41 to step S42. In step S42 as in step S2 shown in FIG. 14, the controller 3 analyzes the input sentence to determine whether the dialogue process should be ended. If it is determined in step S42 that the dialogue process should be ended, the dialogue process is ended.

If it is determined in step S42 that the dialogue process should not be ended, the controller 3 supplies the input sentence to the formal response sentence generator 11 and the practical response sentence generator 13 in the response generator 4 (FIG. 2). Thereafter, the controller 3 advances the process to step S43. In step S43, the formal response sentence generator 11 produces a formal response sentence in response to the input sentence and supplies the resultant formal response sentence to the response output controller 16. Thereafter, the process proceeds to step S44.

In step S44, the response output controller 16 determines whether the formal response sentence supplied from the formal response sentence generator 11 satisfies the predefined condition. More specifically, for example, the response output controller 16 determines whether the score evaluated for an input example coupled with a response example employed as the formal response sentence is higher than the predetermined threshold value, or whether the number of words included in the response example employed as the formal response sentence is within the range from C1 to C2.

If it is determined in step S44 that the formal response sentence satisfies the predefined condition, the process proceed to step S45. In step S45, the response output controller 16 outputs the formal response sentence satisfying the predetermined condition to the speech synthesizer 5 via the controller 3 (FIG. 1). Thereafter, the process proceeds to step S46. In response, as described earlier with reference to FIG. 14, the speech synthesizer 5 performs the speech synthesis associated with the formal response sentence.

On the other hand, in the case in which it is determined in step S44 that the formal response sentence does not satisfy the predefined condition, the process jumps to step S46 without performing step S45. That is, in this case, the formal response sentence that does not satisfy the predefined condition is not output as a response.

In step S46, the practical response sentence generator 13 produces a practical response sentence in response to the input sentence and supplies the resultant practical response sentence to the response output controller 16. Thereafter, the process proceeds to step S47.

In step S47, the response output controller 16 determines whether practical response sentence supplied from the practical response sentence generator 13 satisfies the predefined condition. More specifically, for example, the response output controller 16 determines whether the score evaluated for an example located at a position immediately before an example employed as the practical response sentence is higher than the predetermined threshold value, or whether the number of words included in the example employed as the practical response sentence is within the range from C1 to C2.

If it is determined in step S47 that the practical response sentence does not satisfy the predefined condition, the process jumps to step S50 without performing steps S48 and S49. In this case, the practical response sentence that does not satisfy the predefined condition is not output as a response.

When it is determined in sep S47 that the practical response sentence does not satisfy the predefined condition, if it was determined in step S44 that the formal response sentence also does not satisfy the predefined condition, that is, if the fourth case described above occurs, neither the formal response sentence nor the practical response sentence is output. In this case, as described above, the response output controller 16 outputs a predetermined sentence such as “I have no good answer” or “Please say again in a different way” as a final response sentence to the speech synthesizer 5. Thereafter, the process proceeds from step S47 to S50.

On the other hand, in the case in which it is determined in step S47 that the practical response sentence satisfies the predefined condition, the process proceeds to step S48. In step 48, as in step S26 in the flow shown in FIG. 15, the response output controller 16 checks whether the practical response sentence satisfying the predefined condition includes a part (expression) overlapping the formal response sentence output in the immediately previous step S45 to the speech synthesizer 5. If there is such an overlapping part, the response output controller 16 removes the overlapping part from the practical response sentence. Thereafter, the process proceeds to step S49.

When the practical response sentence includes no portion overlapping the formal response sentence, the practical response sentence is maintained without being subjected to any modification in step S48.

In step S49, the response output controller 16 outputs the practical response sentence to the speech synthesizer 5 via the controller 3 (FIG. 1). Thereafter, the process proceeds to step S50. In step S50, the response output controller 16 updates the dialogue log by additionally recording the input sentence and the conclusive response sentence output as a response to the input sentence in the dialogue log of the dialogue log database 15, in a similar manner to step S7 in FIG. 14. Thereafter, the process returns to step S41, and the process is repeated from step S41.

Seventh Modification

In the seventh modified embodiment, the confidence measure of the result of the speech recognition is determined and taken into account in the process of producing a formal response sentence or a practical response sentence by the formal response sentence generator 11 or the practical response sentence generator 13.

In the voice dialogue system shown in FIG. 1, the speech recognizer 2 does not necessarily need to be of a type designed for dedicated use by the voice dialogue system 2, but a conventional speech recognizer (a speech recognition apparatus or a speech recognition module) may also be used.

Some conventional speech recognizers have a capability of determining the confidence measure for each word included in a series of words obtained as a result of speech recognition and outputting the confidential measure together with the result of speech recognition.

More specifically, when a user says “Let's play succor tomorrow morning”, the speech is recognized, for example, as “Let's pray succor morning morning”, and the confidence measure for each word of the recognition result “Let's pray succor morning morning” is evaluated as, for example, Let's(0.98) pray(0.71) succor(0.98) morning(0.1) morning(0.98)”. In this example of the evaluation result “Let's(0.98) pray(0.71) succor(0.98) morning(0.1) morning(0.98)”, each numeral enclosed between parentheses indicates the confidence measure of an immediately previous word. The greater the value of the confidence measure, the greater the likelihood of the recognized word.

In the recognition result “Let's(0.98) pray(0.71) succor(0.98) morning(0.1) morning(0.98)”, for example, a word “succor” is exactly identical to the actually uttered word “succor”, and the confidence measure was evaluated as high as 0.98. On the other hand, the actually uttered word “tomorrow” was incorrectly recognized as “morning”, and the confidence measure for this word was evaluated as low as 0.1.

If the speech recognizer 2 has such a capability of determining the confidence measure for each word of a series of words obtained as a result of speech recognition, the formal response sentence generator 11 or the practical response sentence generator 13 may take into account the confidence measure in the process of producing a formal response sentence or a practical response sentence in response to an input sentence given by the speech recognition.

When an input sentence is given as a result of speech recognition, a word with a high confidence measure is highly likely to be correct. Conversely, a word with a low confidence measure is likely to be wrong.

In the process of evaluating matching between the input sentence and examples, it is desirable that the evaluation of matching be less influenced by a word that is low in the confidence measure and thus is likely to be wrong than a word that is likely to be correct.

Thus the formal response sentence generator 11 or the practical response sentence generator 13 takes into account the confidence measure evaluated for each word included in an input sentence in the calculation of the score associated matching between the input sentence and examples such that a word with a low confidence measure does not have a significant contribution to the score.

More specifically, in the case in which the evaluation of matching between an input sentence and examples is performed using the vector space method, the value of each element of a vector (vector y in equation (1)) representing the input sentence is given not by tf (the number of occurrences of a word corresponding to the element of the vector) but by the sum of values of the confidence measure of the word corresponding to the element of the vector.

In the example described above in which the input sentence is recognized as “Let's(0.98) pray(0.71) succor(0.98) morning(0.1) morning(0.98)”, the value of the each element of the vector of the input sentence is given such that the value of the element corresponding to “Let's” is given by the confidence measure of “Let's” 0.98, the value of the element corresponding to “pray” is given by the confidence measure of “pray” 0.71, the value of the element corresponding to “succor” is given by the confidence measure of “succor” 0.71, and the value of the element corresponding to “morning” is given by the sum of confidence measures for two occurrences of “morning”, that is, 0.1+0.98=1.08.

In the case in which the evaluation of matching between an input sentence and exampleal is performed using the DP matching method, the weight of each word may be given by the confidence measure of the word.

More specifically, in the present example in which the input sentence is recognized as “Let's(0.98) pray(0.71) succor(0.98) morning(0.1) morning(0.98)”, the words “Let's”, “pray”, “succor”, “morning”, and “morning” are respectively weights by factors 0.98, 0.71, 0.98, 0.1, and 0.98.

In the case of Japanese, as described earlier, particles and auxiliary verbs have significant contributions to the form of a sentence. Therefore, when the formal response sentence generator 11 evaluates the matching between an input sentence and an example which is a candidate for a formal response sentence, it is desirable that particles and auxiliary verbs have significant contributions to the score of the matching.

However, in the formal response sentence generator 11, when the evaluation of the matching is simply performed such that particles and auxiliary verbs have significant contributions, if the input sentence obtained as a result of speech recognition includes incorrectly recognized particle or auxiliary verb, the score of the matching is strongly influenced by the incorrect particle or auxiliary verb, and thus a formal response sentence which is unnatural as a response to the input sentence is produced.

The above problem can be avoided by weighting each word included in the input sentence by a factor determined based on the confidence measure in the calculation of the score of the matching between an input sentence and examples such that the score is not strongly influenced by a word that is low in the confidence measure, that is, a word that is likely to be wrong. This prevents outputting a formal response sentence that is unnatural as a response to a speech of a user.

Various methods are known to calculate the confidence measure, and any method may be used herein as long as the method can determine the confidence measure of each word included in a sentence obtained as a result of speech recognition.

An example of a method of determining the confidence of measure on a word-by-word basis is described below.

For example, when the speech recognizer 2 (FIG. 1) performs speech recognition using the HMM (Hidden Markov Model) method, the confidence measure may be calculated as follows.

In general, in the speech recognition based on the HMM acoustic model, recognition is performed in units of phonemes or syllables, and words are modeled in the form of HMM concatenations of phonemes or syllables. In speech recognition, if an input voice signal is not correctly separated into phonemes or syllables, a recognition error can occur. In other words, if boundaries between adjacent phonemes to be separated from each other are correctly determined, phonemes can be correctly recognized and thus words or a sentence can be correctly recognized.

Herein, let us introduce a phoneme boundary verification measure (PBVM) to verify whether, in speech recognition, an input voice signal is separated into phonemes at correct boundaries. In the speech recognition process, the PBVM is determined for each phoneme of the input voice signal, and the PBVM determined on a phoneme-by-phoneme basis is extended to a PBVM of each word. The PBVM of each word determined in this way is employed as the confidence measure of the word.

The PBVM may be calculated, for example, as follows.

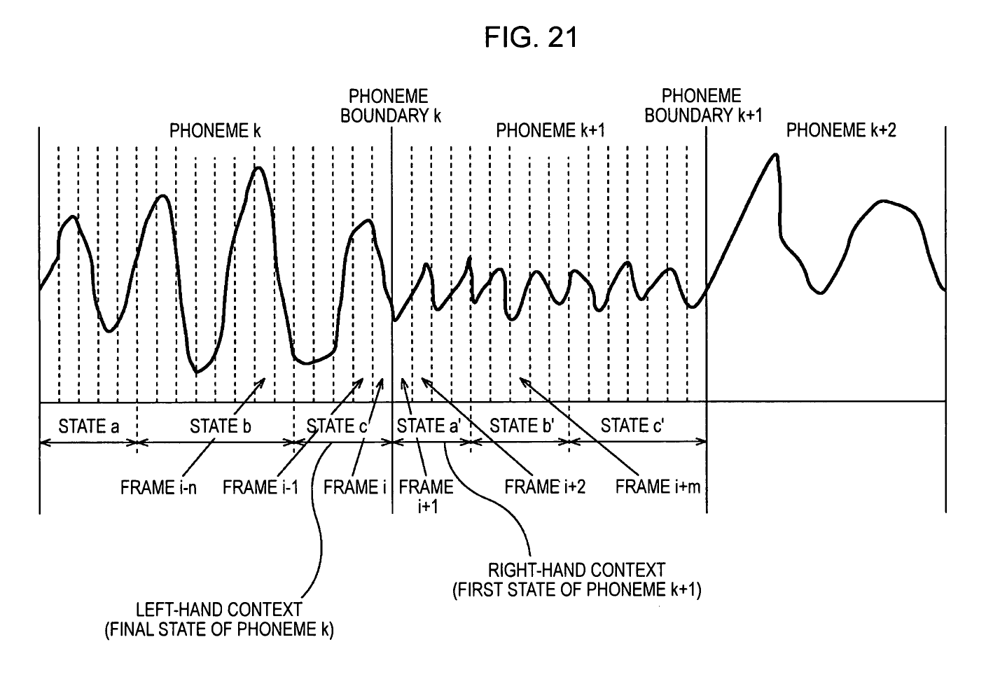

First, contexts (which are successive in time) located on left-hand and right-hand sides of a boundary between a phoneme k and a next phoneme k+1 in a speech recognition result (in the form of a series of words). The contexts on left-hand and right-hand sides of the phoneme boundary may be defined in one of three ways shown in FIGS. 21 to 23.

FIG. 21 shows a first way in which the contexts on left-hand and right-hand sides of the phoneme boundary are defined.

FIG. 21 shows phonemes k, k+1, and k+2, a phoneme boundary k between phonemes k and k+1, and a phoneme boundary k+1 between phonemes k+1 and k+2 in a series of recognized phonemes. For the phonemes k and k+1, frame boundaries of a voice signal are denoted by dashed lines. For example, the last frame of the phoneme k is denoted as frame i, the first frame of the phoneme k+1 is denoted as frame i+1, and so on. In the phoneme k, HMM states change from a to b and further to c. In the phoneme k+1, HMM states change from a′ to b′, and further to c′.

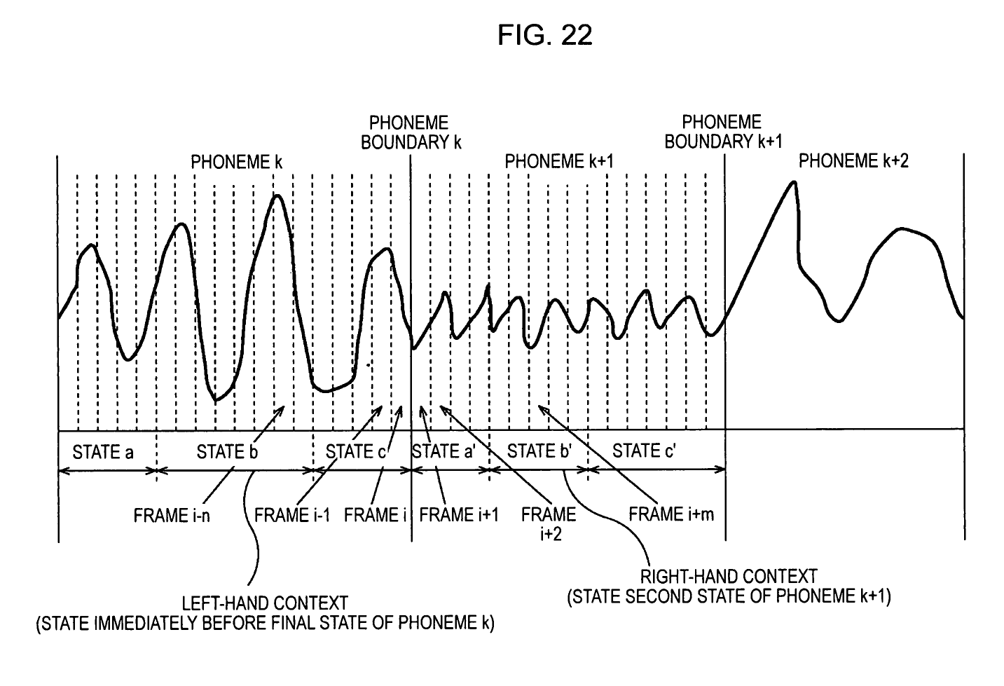

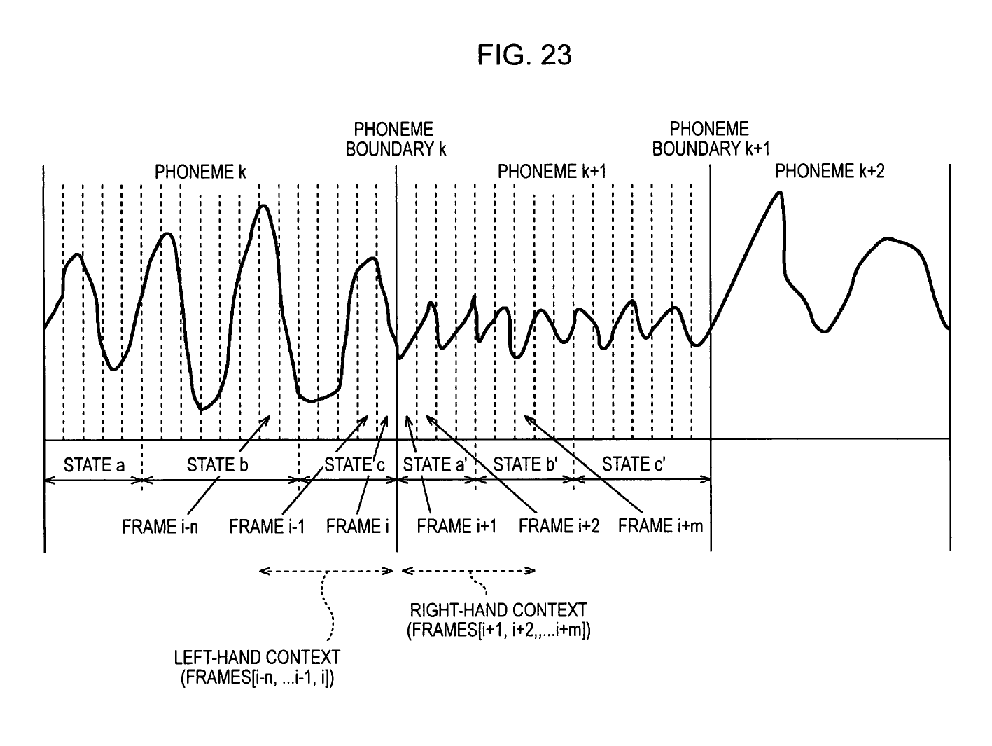

In FIG. 21 (and also in FIGS. 22 and 23), a solid curve represents a change in power of the voice signal.

In the first definition of two contexts on left-hand and right-hand sides of the phoneme boundary k, as shown in FIG. 21, the context on the left-hand side of the phoneme boundary k (that is, the context at the position in time immediately before the phoneme boundary k) includes all frames (frames i−4 to i) corresponding to the HMM state c, and the context on the right-hand side of the phoneme boundary k (that is, the context at the position in time immediately after the phoneme boundary k) includes all frames (frames i+1 to i+4) corresponding to the HMM state c′.

FIG. 22 shows a second definition of the contexts on left-hand and right-hand sides of the phoneme boundary. In FIG. 22 (and also in FIG. 23 described later), similar parts to those in FIG. 21 are denoted by similar reference numerals or symbols, and a further description of these similar parts is omitted.

In the second definition of two contexts on left-hand and right-hand sides of the phoneme boundary k, as shown in FIG. 22, the context on the left-hand side of the phoneme boundary k includes all frames corresponding to the HMM state b immediately before the last HMM state of the phoneme k, and the context on the right-hand side of the phoneme boundary k includes all frames corresponding to the second HMM state b′ of the phoneme k+1.

FIG. 23 shows a third definition of the contexts on left-hand and right-hand sides of the phoneme boundary.

In the third definition of two contexts on left-hand and right-hand sides of the phoneme boundary k, as shown in FIG. 23, the context on the left-hand side of the phoneme boundary k includes frames i−n to i, and the context on the right-hand side of the phoneme boundary k includes frames i+1 to i+m, where n and m are integers equal to or greater than 1.

A vector representing a context is introduced herein to determine the similarity between two contexts on left-hand and right-hand sides of the phoneme boundary k.

For example, when a spectrum is extracted as a feature value of a voice on a frame-by-frame basis in speech recognition, a context vector (a vector representing a context) may be given by the average of vectors whose elements are given by respective coefficients of a spectrum of each frame included in the context.

When two context vectors x and y are given, the similarity function s(x, y) indicating the similarity between the vectors x and y can be given by the following equation (14) based on the vector space method.

$$s ( x , y ) = \frac{{x}^{t} y}{\vert x \vert \vert y \vert} \qquad ( 14 )$$

|x| and |y| denote the length of the vector x and y, and x^{t} denotes the transpose of the vector x. Note that the similarity function s(x, y) given by equation (14) is the quotient obtained by dividing the inner product of the vectors x and y, that is, x^{t}y, by the product of the magnitudes of the vectors x and y, that is, |x|·|y|, and thus the similarity function s(x, y) is equal to the cosine of the angle between the two vectors x and y.

Note that the value of the similarity function s(x, y) decreases with increasing similarity between the vectors x and y.

The phoneme boundary verification measure function PBVM(k) for a phoneme boundary k can be expressed using the similarity function s(x, y), for example, as shown in equation (15).

$$PBVM ( k ) = \frac{1 - s ( x , y )}{2} \qquad ( 15 )$$

The function representing the similarity between two vectors is not limited to the similarity function s(x, y) described above, but a distance function d(x, y) indicating two vectors x and y may also be used (note that d(x, y) is normalized in the range from −1 to 1). In this case, the phoneme boundary verification measure function PBVM(k) is given by the following equation (16).

$$PBVM ( k ) = \frac{1 - d ( x , y )}{2} \qquad ( 16 )$$

The vector x (and also vector y) of a context at a phoneme boundary may be given by the average (average vector) of all vectors representing the spectra of the respective frames of the context, wherein elements of the vector representing each spectrum are given by coefficients of the spectrum of the frame of interest). Alternatively, the vector x (and also the vector y) of a context at a phoneme boundary may be given by a vector obtained by subtracting the average of all vectors representing the spectra of the respective frames of the context from a vector representing the spectrum of a frame located closest to the phoneme boundary k. In a case in which the output probability density function of the feature value (the feature vector of a voice) of the HMM can be expressed using a Gaussian distribution, the vector x (and also vector y) of a context at a phoneme boundary may be determined, for example, from an average vector that defines a Gaussian distribution expressing an output probability density function of an HMM state corresponding to frames of the context.

The phoneme boundary verification measure function PBVM(k) of a phoneme boundary k according to equation (15) or 16) is a continuous function of a variable k and takes a value in the range from 0 to 1. When PBVM(k)=0, vectors of contexts on right-hand and left-hand sides of a phoneme boundary k are equal in direction. That is, when the phoneme boundary verification measure PBVM(k) has a value equal to 0, the phoneme boundary k is unlikely to be an actual phoneme boundary, and thus it is likely that a recognition error has occurred.

On the other hand, when the phoneme PBVM(k) has a value equal to 1, vectors of contexts on right-hand and left-hand sides of a phoneme boundary k are opposite in direction, and the phoneme boundary k is likely to be a correct phoneme boundary.

As described above, the phoneme boundary verification measure function PBVM(k) taking a value in the range from 0 to 1 indicates the likelihood that the phoneme boundary k is a correct phoneme boundary.

Because each word of a series of words obtained as a result of speech recognition includes a plurality of phonemes, the confidence measure of each word can be determined from the likelihood of phoneme boundaries k of the word, that is, from the phoneme boundary verification measure function PBVM of phonemes of the word.

More specifically, the confidence measure of a word may be given by, for example, the average of the values of the phoneme boundary verification measure PBVM of phonemes of the word, the minimum value of the values of the phoneme boundary verification measure PBVM of phonemes of the word, the difference between the maximum and minimum values of the phoneme boundary verification measure PBVM of phonemes of the word, the standard deviation of the values of the phoneme boundary verification measure PBVM of phonemes of the word, or the coefficient of variation (quotient of division of the standard deviation by the average) of the values of the phoneme boundary verification measure PBVM of phonemes of the word.

As for the confidence measure, other values may also be used, such as the difference between the score of the most likely candidate and the score of the next most likely candidate for recognition of the word, as described, for example, in Japanese Unexamined Patent Application Publication No. 9-259226. The confidence measure may also determined from acoustic scores of respective frames calculated from HMM, or may be determined using a neural network.

Eighth Modification

In the eighth modified embodiment, when the practical response sentence generator 13 produces a response sentence, expressions recorded in a dialogue log is also used as examples.

In the embodiments described earlier with reference to FIG. 10 or 11, when the practical response sentence generator 13 produces a practical response sentence, the dialogue log recorded in the dialogue log database 15 (FIG. 2) is supplementarily used in the calculation of the score associated with the matching between an input sentence and an example. In contrast, in the present modified embodiment, the practical response sentence generator 13 uses expressions recorded in the dialogue log as examples when the practical response sentence generator 13 produces a practical response sentence.

When expressions recorded in the dialogue log are used as examples, all speeches (FIG. 9) recorded in the dialogue log database 15 may be simply dealt with in a similar manner to the examples recorded in the example database 14. However, in this case, if a conclusive response sentence output from the response output controller 16 (FIG. 2) is not suitable as a response to an input sentence, this unsuitable response sentence can cause an increase in the probability that an unsuitable sentence is produced as a practical response sentence in the following dialogue.

To avoid the above problem, when expressions recorded in the dialogue log are used as examples, it is desirable that of speeches recorded in the <dialogue log such as that shown in FIG. 9, speeches of a particular talker be preferentially employed in the production of a practical response sentence.

More specifically, for example, in the dialogue log shown in FIG. 9, speeches whose talker is a “user” (for example, speeches with speech numbers r−4 and r−2 in FIG. 9) are preferentially employed as examples for use in the production of a practical response sentence rather than speeches of the other talkers (speeches of the “system” in the example shown in FIG. 9). The preferential use of past speeches of the user can give, to the user, an impression that the system is learning a language.

In the case in which expressions of speeches recorded in the dialogue log are used as examples, as in the fourth modified embodiment, speeches may be recorded on a group-by-group basis, and, in the evaluation of matching between an input sentence and examples, the score may be weighted depending on the group as in equation (13) so that an example relating to a current topic is preferentially selected as a practical response sentence.

For the above purpose, it is needed to group the speeches depending on, for example, topics, and record the speeches in the dialogue log on a group-by-group basis. This can be done, for example, as follows.

In the dialogue log database 15, changes in topic in a talk with a user is detected, and speeches (input sentences and response sentences to the respective input sentences) from a speech immediately after an arbitrary change in topic to a speech immediately before the next change in topic are stored in one dialogue log file such that speeches of a particular topic is stored in a particular dialogue log file.

A change in topic can be detected by detecting an expression indicating a change in topic, such as “By the way”, “Not to change the subject”, or the like in a talk. More specifically, many expressions indicating a change in topic are prepared as examples, and when the score between an input sentence and one of the examples of topic change is equal to or higher than a predetermined threshold value, it is determined that a change in topic has occurred.

When a user does not say anything for a predetermined time, it may be determined that a change in topic has occurred.

In the case in which dialogue logs are stored in different files depending on topics, when a dialogue process is started, a dialogue log file of the dialogue log database 15 is opened, and input sentences and conclusive response sentences to the respective input sentences, supplied from the response output controller 16, are written as speeches in the opened file (FIG. 9). If a change in topic is detected, the current dialogue log file is closed, and a new dialogue log file is opened, and input sentences and conclusive response sentences to the respective input sentences, supplied from the response output controller 16, are written as speeches in the opened file (FIG. 9). The operation is continued in a similar manner.

The file name of each dialogue log file may be given, for example, by a concatenation of a word indicating a topic, a serial number, and a particular extension (xxx). In this case, dialogue log files with file names subject0.xxx, subject1.xxx and so on are stored one by one in the dialogue log database 15.

To use speeches recorded in the dialogue log as examples, it is needed to open all dialogue logs stored in the dialogue log database 15 at least in a read-only mode during the dialogue process so that speeches recorded in the dialogue logs can be read during the dialogue process. An dialogue log file that is used to record input sentences and response sentences to the respective input sentences in a current talk should be opened in a read/write mode.

Because the storage capacity of the dialogue log database 15 is limited, dialogue log files whose speeches are unlikely to be used as practical response sentences (examples) may be deleted.

Ninth Modification

In the ninth modified embodiment, a formal response sentence or a practical response sentence is determined based on the likelihood (the score indicating the likelihood) of each of N best speech recognition candidates and also based on the score of matching between each example and each speech recognition candidate.

In the previous embodiments and modified embodiment, the speech recognizer 2 (FIG. 1) outputs a most likely recognition candidate of all recognition candidates as a speech recognition result. Instead, in the ninth modified embodiment, the speech recognizer 2 outputs N recognition candidates that are high in likelihood as input sentences together with information indicating the likelihood of the respective input sentences. The formal response sentence generator 11 or the practical response sentence generator 13 evaluates matching between each of N high-likelihood recognition candidates given as the input sentences and examples and determines a tentative score for each example with respect to each input sentence. A total score for each example with respect to each input sentence is then determined from the tentative score for each example with respect to each input sentence taking into account the likelihood of each of N input sentences (N recognition candidates).

If the number of examples recorded in the example database 12 or 14 is denoted by P, the formal response sentence generator 11 or the practical response sentence generator 13 evaluation matching between each of N input sentence and each of P examples. That is, the matching evaluation is performed as many times as N×P.

In the evaluation of matching, the total score is determined for each input sentence, for example, according to equation (17).
total_{—}score(input sentence #n, example #p)=g(recog_{—}score(input sentence #n), match_{—}score(input sentence #n, example #p)) (17)
where “input sentence #p” denotes an n-th input sentence of the N input sentence (N high-likelihood recognition candidates), “example #p” denotes a p-th example of the P examples, total_score(input sentence #n, example #p) is the total score of the example #p with respect to the input sentence #n, recog_score(input sentence #n) is the likelihood of the input sentence (recognition candidate) #n, and match_score(input sentence #n, example #p) is the score that indicates the similarity of the example #p with respect to the input sentence #n and that is determined using the vector space method or the DP matching method described earlier. In equation (17), function g(a, b) of two variables an and b is a function that monotonically increases with each of variables an and b. As for function g(a, b), for example, g(a, b)=c₁a+c₂b (c₁ and c₂ are non-negative constants) or g(a, b)=ab may be used.

The formal response sentence generator 11 or the practical response sentence generator 13 determines the total score total_score(input sentence #n, example #p) for each of P examples with respect to each of N input sentences in accordance with equation (17), and employs an example having a highest value of total_score(input sentence #n, example #p) as a formal response sentence or a practical response sentence.

The formal response sentence generator 11 and the practical response sentence generator 13 may have a highest value of total_score(input sentence #n, example #p) for the same input sentence or for different input sentences.

If total_score(input sentence #n, example #p) has a highest value for different input sentences for the formal response sentence generator 11 and the practical response sentence generator 13, then this situation can be regarded as equivalent to a situation in which different input sentences as a result of speech recognition for the same speech uttered by a user are supplied to the formal response sentence generator 11 and the practical response sentence generator 13. This causes a problem of how to record different input sentences of the same utterance as a speech in the dialogue log database 15.

In a case in which the formal response sentence generator 11 evaluates the matching of examples without using the dialogue log while the practical response sentence generator 13 evaluates the matching of examples using dialogue log, a solution to the above problem is to employ an input sentence #n that gets a highest total_score(input sentence #n, example #p) in the evaluation performed by the practical response sentence generator 13 as a speech to be recorded in the dialogue log.

More simply, an input sentence #n₁ that gets a highest total_score(input sentence #n₁, example #p) in the evaluation performed by the formal response sentence generator 11 and an input sentence #n₂ that gets a highest total_score(input sentence #n₂, example #p) in the evaluation performed by the practical response sentence generator 13 may both be recorded in the dialogue log.

In the case in which both input sentences #n₁ and #n₂ are recorded in the dialogue log, it is required that in the evaluation of matching based on the dialogue log (both in the matching described earlier with reference to FIGS. 10 to 12 and in the matching using expressions of speeches recorded in the dialogue log as examples), two input sentences #n₁ and #n₂ should be treated as one speech.

To meet the above requirement, in the case in which the evaluation of matching is performed using the vector space method, for example, the average vector (V₁+V₂)/2 of a vector V₁ representing the input sentence #n₁ and a vector V₂ representing the input sentence #n₂ is treated as a vector representing one speech corresponding to the two input sentences #n₁ and #n₂.

Tenth Modification

In the tenth modified embodiment, the formal response sentence generator 11 produces a formal response sentence using an acoustic feature of a speech of a user.

In the previous embodiments and modified embodiments, a result of speech recognition of an utterance of a user is given as an input sentence, and the formal response sentence generator 11 evaluates matching between the given input sentence and examples in the process of producing a formal response sentence. In contrast, in the tenth modified embodiment, in the process of producing a formal response sentence, the formal response sentence generator 11 uses an acoustic feature of an utterance of a user instead of or together with an input sentence.

As for the acoustic feature of an utterance of a user, for example, the utterance length (voice period) of the utterance or metrical information associated with rhyme may be used.

For example, the formal response sentence generator 11 may produce a formal response sentence including a repetition of the same word depending on the utterance length of an utterance of a user, such as “uh-huh”, “uh-huh, uh-huh”, “uh-huh, uh-huh, uh-huh” and so on such that the number of repletion words increases with the utterance length.

The formal response sentence generator 11 may also produce a formal response sentence such that the number of words included in the formal response sentence increases with the utterance length, such as “My!”, “My God!”, “Oh, my God!” and so on. To produce a formal response sentence such that the number of words increases with the utterance length, for example, weighting is performed depending on the utterance length in the evaluation of matching between an input sentence and examples such that an example including a great number of words gets a high score. Alternatively, examples including various numbers of words corresponding to various values of the utterance length may be prepared, and an example including a particular number of words corresponding to an actual utterance length may be selected as a formal response sentence. In this case, because a result of speech recognition is used in the production of the formal response sentence, it is possible to quickly obtain the formal response sentence. A plurality of examples may be prepared for the same utterance length, and one of the examples may be selected at random as a formal response sentence.

Alternatively, the formal response sentence generator 11 may employ an example with a highest score as a formal response sentence, and the speech synthesizer 5 (FIG. 1) may decrease the playback speed (output speed) of the synthesized voice corresponding to the formal response sentence with increasing utterance length.

In any case, the time from the start to the end of outputting of the synthesized voice corresponding to the formal response sentence increases with the utterance length. As described earlier with reference to the flow chart shown in FIG. 14, if the response output controller 16 outputs the formal response sentence immediately after the formal response sentence is produced, without waiting for the practical response sentence to be produced, it is possible to prevent an increase in the response time from the end of an utterance made by a user to the start of outputting of a synthesized voice as a response to the utterance, and thus it is possible to prevent an unnatural pause from occurring between the outputting of the formal response sentence and the outputting of the practical response sentence.

More specifically, when the utterance length of an utterance of a user is long, the speech recognizer 2 (FIG. 1) needs a long time to obtain a result of speech recognition, and the practical response sentence generator 13 needs a long time to evaluate matching between a long input sentence given as the result of speech recognition and examples. Therefore, if the formal response sentence generator 11 starts the evaluation of matching to produce a formal response sentence after a result of speech recognition is obtained, it takes a long time to obtain a formal response sentence and thus the response time becomes long.

In the practical response sentence generator 13, it takes a longer time to obtain a practical response sentence than needed to produce the <formal response sentence, because it is needed to evaluate matching for a greater number of examples than the number of examples evaluated by the formal response sentence generator 11. Therefore, there is a possibility that when outputting of the synthesized voice of the formal response sentence is completed, the production of the practical response sentence is not yet completed. In this case, a natural pause occurs between the end of the outputting of the formal response sentence and the start of outputting of the practical response sentence.

To avoid the above problem, the formal response sentence generator 11 produces a formal response sentence in the form of a repetition of the same words whose number of occurrences increases with the utterance length, and the response output controller 16 outputs the formal response sentence without waiting for the production of the practical response sentence such that the formal response sentence is output immediately after the end of the utterance of a user. Furthermore, because the number of words such as “uh-huh” repeated in the formal response sentence increases with the utterance length, the time during which the formal response sentence is output in the form of a synthesized voice increases with the utterance length. This makes it possible for the speech recognizer 2 to obtain a result of speech recognition and the practical response sentence generator 13 to obtain a practical response sentence in the time during which the formal response sentence is output. As a result, it becomes possible to avoid an unnatural pause such as that described above.

In the production of a formal response sentence by the formal response sentence generator 11, metrical information such as a pitch (frequency) may be used instead of or in addition to the utterance length of an utterance of a user.

More specifically, the formal response sentence generator 11 determines whether a sentence uttered by a user is in a declarative or interrogative form, based on a change in pitch of the utterance. If the uttered sentence is in the declarative form, an expression such as “I see” appropriate as a response to a declarative sentence may be produced as a formal response sentence. On the other hand, when the sentence uttered by the user is in the interrogative form, the formal response sentence generator 11 pay produce a formal response sentence such as “Let me see” appropriate as a response to an interrogative sentence. The formal response sentence generator 11 may change the length of such a formal response sentence depending on the utterance length of an utterance of a user, as described above.

The formal response sentence generator 11 may guess the emotional state of a user and may produce a formal response sentence depending on the guessed emotional state. For example, if the user is emotionally exciting, the formal response sentence generator 11 may produce a formal response sentence to affirmatively respond to an utterance of the user without getting the user more excited.

The guessing of the emotional state of a user may be performed, for example, using a method disclosed in Japanese Unexamined Patent Application Publication No. 5-12023. The production of a response sentence depending on the emotional state of a user may be performed, for example, using a method disclosed in Japanese Unexamined Patent Application Publication No. 8-339446.

The process of extracting the utterance length or the metrical information of a sentence uttered by a user and the process of guessing the emotional state of the user generally need less amount of computation than the speech recognition process. Therefore, in the formal response sentence generator 11, producing of a formal response sentence based not on an input sentence obtained as a result of speech recognition but on an utterance length, metrical information, and/or a user's emotional state makes it possible to further reduce the response time (from the end of a speech uttered by a user to the start of outputting of a response).

The sequence of processing steps described above may be performed by means of hardware or software. When the processing sequence is executed by software, a program forming the software is installed on a general-purpose computer or the like.

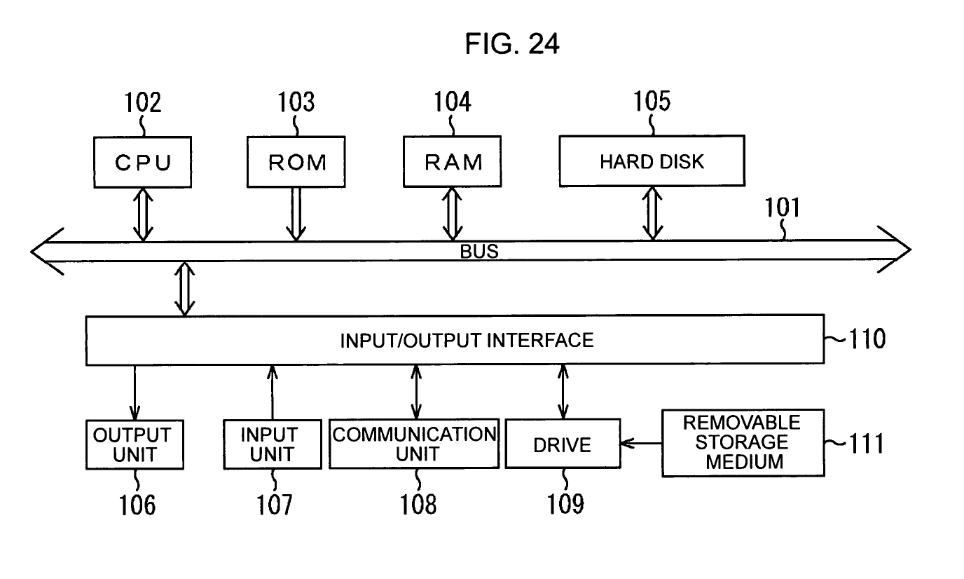

FIG. 24 illustrates a computer in which a program for executing the above-described processes is installed, according to an embodiment of the invention.

The program may be stored, in advance, on a hard disk 105 or a ROM 103 serving as a storage medium, which is disposed inside the computer.

The program may also be temporarily or permanently stored in a removable storage medium 111 such as a flexible disk, a CD-ROM (Compact Disc Read Only Memory), an MO (Magneto-optical) disk, a DVD (Digital Versatile Disc), a magnetic disk, or a semiconductor memory. The program stored on such a removable storage medium 111 may be supplied in the form of so-called packaged software.

Instead of installing the program from the removable storage medium 111 onto the computer, the program may also be transferred to the computer from a download site via radio transmission or via a network such as a LAN (Local Area Network) or the Internet by means of wire communication. In this case, the computer receives the program via the communication unit 108 and installs the received program on the hard disk 105 disposed in the computer.

The computer includes a CPU (Central Processing Unit) 102. An input/output interface 110 is connected to the CPU 102 via a bus 101. If the CPU 102 receives, via the input/output interface 110, a command issued by a user using an input unit 107 including a keyboard, a mouse, microphone, or the like, the CPU 102 executes the program stored in a ROM (Read Only Memory) 103. Alternatively, the CPU 102 may execute a program loaded in a RAM (Random Access Memory) 104 wherein the program may be loaded into the RAM 104 by transferring a program stored on the hard disk 105 into the RAM 104, or transferring a program which has been installed on the hard disk 105 after being received from a satellite or a network via the communication unit 108, or transferring a program which has been installed on the hard disk 105 after being read from a removable recording medium 111 loaded on a drive 109. By executing the program, the CPU 102 performs the process described above with reference to the flow charts or the block diagrams. The CPU 102 outputs the result of the process, as required, to an output device 106 including an LCD (Liquid Crystal Display) and/or a speaker via the input/output interface 110. The result of the process may also be transmitted via the communication unit 108 or may be stored on the hard disk 105.

In the present invention, the processing steps described in the program to be executed by a computer to perform various kinds of processing are not necessarily required to be executed in time sequence according to the order described in the flow chart. Instead, the processing steps may be performed in parallel or separately (by means of parallel processing or object processing).

The program may be executed either by a single computer or by a plurality of computers in a distributed fashion. The program may be transferred to a computer at a remote location and may be executed thereby.

In the embodiments described above, examples recorded in the example database 12 used by the formal response sentence generator 11 are described in the form in which each record includes a set of an input example and a corresponding response example as shown in FIG. 3, while examples recorded in the example database 14 used by the practical response sentence generator 13 are described in the form in which each record includes one speech as shown in FIG. 7. Alternatively, examples recorded in the example database 12 may be described such that each record includes one speech as with the example database 14. Conversely, examples recorded in the example database 14 may be described such that each record includes a set of an input example and a corresponding response example with the example database 12.

Any technique described above only for one of the formal response sentence generator 11 and practical response sentence generator 13 may be applied to the other one as required.

The voice dialogue system shown in FIG. 1 may be applied to a wide variety of apparatus or systems such as a robot, a virtual character displayed on a display, or a dialogue system having a translation capability.

Note that in the present invention, there is no particular restriction on the language treated by the voice dialogue system, and the invention can be applied to a wide variety languages such as English and Japanese.

It should be understood by those skilled in the art that various modifications, combinations, sub-combinations and alterations may occur depending on design requirements and other factors insofar as they are within the scope of the appended claims or the equivalents thereof.

What is claimed is:

1. A dialogue apparatus for interacting by outputting a response sentence in response to an input sentence, comprising:
formal response sentence acquisition means for acquiring a formal response sentence in response to the input sentence;
practical response sentence acquisition means for acquiring a practical response sentence in response to the input sentence; and
output control means for controlling outputting of the formal response sentence and the practical response sentence such that a conclusive response sentence is output in response to the input sentence.

2. A dialogue apparatus according to claim 1, further comprising example storage means for storing one or more examples,
wherein the formal response sentence acquisition means or the practical response sentence acquisition means acquires the formal response sentence or the practical response sentence based on the input sentence and an example.

3. A dialogue apparatus according to claim 2, further comprising dialogue log storage means for storing, as a dialogue log, the input sentence or a conclusive response sentence to the input sentence,
wherein in acquisition of the formal response sentence or the practical response sentence, the formal response sentence acquisition means or the practical response sentence acquisition means takes into account the dialogue log.

4. A dialogue apparatus according to claim 3, wherein the formal response sentence acquisition means or the practical response sentence acquisition means acquires the formal response sentence or the practical response sentence by using an expression included in the dialogue log as an example.

5. A dialogue apparatus according to claim 3, wherein the dialogue log storage means records the dialogue log separately for each topic.

6. A dialogue apparatus according to claim 2, wherein the formal response sentence acquisition means or the practical response sentence acquisition means evaluates matching between the input sentence and examples by using a vector space method, and acquires the formal response sentence or the practical response sentence based an example that got a high score in the evaluation of matching.

7. A dialogue apparatus according to claim 2, wherein the formal response sentence acquisition means or the practical response sentence acquisition means evaluates matching between the input sentence and examples by using a DP (Dynamic Programming) matching method, and acquires the formal response sentence or the practical response sentence based on an example that got a high score in the evaluation of matching.

8. A dialogue apparatus according to claim 7, wherein the formal response sentence acquisition means or the practical response sentence acquisition means weights each word included in the input sentence by factors determined by df (Document Frequency) or idf (Invert Document Frequency), evaluates the matching between the weighted input sentence and examples, and acquires the formal response sentence or the practical response sentence based on an example that got a high score in the evaluation of the matching.

9. A dialogue apparatus according to claim 2, wherein the formal response sentence acquisition means or the practical response sentence acquisition means acquires the formal response sentence or the practical response sentence such that:
the evaluation of matching between the input sentence and examples is performed first using the vector space method;
the matching between the input sentence and a plurality of examples that got high scores in the evaluation of the matching using the vector space method is further evaluated using a DP (Dynamic Programming) matching method; and
the formal response sentence or the practical response sentence is acquired based on an example that got a high score in the evaluation of the matching using the DP matching method.

10. A dialogue apparatus according to claim 2, wherein the practical response sentence acquisition means employs an example similar to the input sentence as the practical response sentence.

11. A dialogue apparatus according to claim 10, wherein the practical response sentence acquisition means employs an example, which is similar to the input sentence but not completely identical to the input sentence, as the practical response sentence.

12. A dialogue apparatus according to claim 2, wherein:
the example storage means stores examples in the same order as the order of utterance; and
the practical response sentence acquisition means selects an example that is located at a position following an example similar to the input sentence and that is different from a practical response sentence output the previous time and the practical response sentence acquisition means employs the selected example as the practical response sentence to be output this time.

13. A dialogue apparatus according to claim 2, wherein:
the example storage means stores examples and information indicating talkers of the respective examples such that the examples and the corresponding talkers linked; and
the practical response sentence acquisition means acquires the practical response sentence taking into account the information about the talkers.

14. A dialogue apparatus according to claim 2, wherein:
the example storage means stores the examples separately on a group-by-group basis; and
the practical response sentence acquisition means acquires a practical response sentence to be output this time, by evaluating matching between the input sentence and examples based on the similarity between a group of examples to be evaluated in matching with the input sentence and a group of examples one of which was employed as a practical response sentence output the previous time.

15. A dialogue apparatus according to claim 2, wherein:
the example storage means stores an example whose one or more parts are in the form of variables; and
the practical response sentence acquisition means acquires the practical response sentence by replacing the one or more variables included in the example with particular expressions.

16. A dialogue apparatus according to claim 2, further comprising speech recognition means for recognizing a speech and outputting a result of speech recognition as the input sentence and also outputting a confidence measure of each word included in the sentence obtained as the result of the speech recognition,
wherein the formal response sentence acquisition means or the practical response sentence acquisition means acquires the formal response sentence or the practical response sentence by evaluates the matching between the input sentence and an example taking into account the confidence measure.

17. A dialogue apparatus according to claim 2, further comprising speech recognition means for recognizing a speech and outputting a result of speech recognition as the input sentence,
wherein the formal response sentence acquisition means or the practical response sentence acquisition means acquires the formal response sentence or the practical response sentence in accordance with a score obtained in the evaluation of matching between the input sentence and an example taking into account a score indicating the likelihood of the result of speech recognition.

18. A dialogue apparatus according to claim 1, wherein the formal response sentence acquisition means and the practical response sentence acquisition means respective acquire a formal response sentence and a practical response sentence by using different methods.

19. A dialogue apparatus according to claim 1, wherein the output control means determines whether the formal response sentence or the practical response sentence satisfies a predefined condition, and the output control means outputs the formal response sentence or the practical response sentence when the formal response sentence or the practical response sentence satisfies the predefined condition.

20. A dialogue apparatus according to claim 1, further comprising speech recognition means for recognizing a speech and outputting a result of speech recognition as the input sentence;
wherein the formal response sentence acquisition means acquires the formal response sentence based on an acoustic feature of the speech; and
the practical response sentence acquisition means acquires the practical response sentence based on the input sentence.

21. A dialogue apparatus according to claim 1, wherein the output control means outputs the formal response sentence and subsequently outputs the practical response sentence.

22. An dialogue apparatus according to claim 21, wherein the output control means removes an overlap between the formal response sentence and the practical response sentence from the practical response sentence and outputs the resultant practical response sentence.

23. A dialogue apparatus according to claim 1, wherein the output control means concatenates the formal response sentence and the practical response sentence and outputs a result.

24. A method of interacting by outputting a response sentence in response to an input sentence, comprising the steps of:
acquiring a formal response sentence in response to the input sentence;
acquiring a practical response sentence in response to the input sentence; and
controlling outputting of the formal response sentence and the practical response sentence such that a conclusive response sentence is output in response to the input sentence.

25. A program for causing a computer to interact by outputting a response sentence in response to an input sentence, the program comprising the steps of:
acquiring a formal response sentence in response to the input sentence;
acquiring a practical response sentence in response to the input sentence; and
controlling outputting of the formal response sentence and the practical response sentence such that a conclusive response sentence is output in response to the input sentence.

26. A storage medium including a program stored therein for causing a computer to interact by outputting a response sentence in response to an input sentence, the program comprising the steps of:
acquiring a formal response sentence in response to the input sentence;
acquiring a practical response sentence in response to the input sentence; and
controlling outputting of the formal response sentence and the practical response sentence such that a conclusive response sentence is output in response to the input sentence.

27. A dialogue apparatus for interacting by outputting a response sentence in response to an input sentence, comprising:
a formal response sentence acquisition unit configured to acquire a formal response sentence in response to the input sentence;
a practical response sentence acquisition unit configured to acquire a practical response sentence in response to the input sentence; and
an output unit configured to control outputting of the formal response sentence and the practical response sentence such that a conclusive response sentence is output in response to the input sentence.
